(19) United States
(12) Patent Application Publication
(10) Pub. No.: US 2026/0191182 A1
(43) Pub. Date: Jul. 9, 2026

(54) Rodent Abatement

(71) Applicant: Gifford Lane, LLC, Bellingham, WA (US)

(72) Inventor: Gifford Lane Gaynor, Bellingham, WA (US)

(73) Assignee: Gifford Lane, LLC, Bellingham, WA (US)

(21) Appl. No.: 19/131,535

(22) PCT Filed: Nov. 21, 2023
(86) PCT No.: PCT/US23/80623

§ 371 Date: May 21, 2025

Related U.S. Application Data
(60) Provisional application No. 63/384,599, filed on Nov. 21, 2022.

(51) Int. Cl. A01M 23/38

(52) U.S. Cl. CPC A01M 23/38

(57) ABSTRACT

An apparatus includes a chamber, an electrically conductive graspable member, and a power supply. The power supply is coupled to the electrically conductive graspable member and arranged to deliver an electric signal to the electrically conductive graspable member. The electric signal has sufficient energy to exceed a let-go threshold of a target rodent's prehensile body part. When the target rodent cannot let go of the electrified graspable electrode, it is eradicated.

### BACKGROUND

### Technical Field

The present disclosure generally relates to electrified rodent traps. More particularly, but not exclusively, the present disclosure relates to rodent traps that exploit the response of a rodent's prehensile body parts to an electric energy that exceeds a let-go threshold.

### Description of the Related Art

Some aspects of technologies and related art that may be useful in understanding the background of the present disclosure are described in the following publications:
U.S. Pat. No. 2,191,229 to Ford, which is entitled, “Exterminating Apparatus,” describes an electric trap with a steeply inclined, electrically conductive climbing structure from which an electrocuted rat should fall. Ford's trap is energized by the bait grabbing movements of a rat. The current flow path is from the nose or mouth through the body of the rat.
U.S. Pat. No. 5,406,742 to Allen, which is entitled “Animal Trap,” describes an electrically conductive base plate and a ladder that can be ascended by a possum. Allen's design employs an electrically released pivotable base plate that tips to cause the dead possum to drop out of the trap after it is electrocuted.
U.S. Pat. No. 8,505,235 to Rich, which is entitled, “CPU-Controlled, Reaming Electronic Animal Trap With Three-Killing-Plate Configuration” describes a device that utilizes charged planar plates. Rich's design relies on a nuisance animal contacting the planar plates.

Electrocution of nuisance animals has been tried, and in the known cases, it is marginally effective, but only in circumstances where the animal interacts as required by the known devices.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

The following is a summary of the present disclosure to provide an introductory understanding of some features and context. This summary is not intended to identify key or critical elements of the present disclosure or to delineate the scope of the disclosure. This summary presents certain concepts of the present disclosure in a simplified form as a prelude to the more detailed description that is later presented.

The device, method, and system embodiments described in this disclosure (i.e., the teachings of this disclosure) exploit the prehensile body parts of a target rodent (e.g., a nuisance animal, a pest, a rat, a squirrel, or the like). A prehensile body part is an appendage (i.e., anatomical structure) with the ability to grasp that is subject to a prehensile response, and a prehensile response can be summarized as grasping in reaction to an external stimulus. Prehensile body parts, as the term is used in the present disclosure, will exhibit an inability to let go of a structure that is carrying a sufficient electrical charge structure. Hands, tails, paws, and the like are prehensile anatomical structures. Popular media has demonstrated prehensile responses, even comically in some cases, when a human wraps the fingers of his hand around an electric fence wire, an electrically charged doorknob, or the like. In these circumstances, the human is shocked, sometimes to the point of death (i.e., electrocution), when the human cannot let go of the charged structure.

Systems, devices, and methods of the present disclosure, teach, for example, immobilizing (e.g., restraining, stunning, killing, euthanizing, or the like) a target rodent in a particular structural embodiment and then subsequently releasing the animal. Immobilization of the target rodent occurs by stimulating a prehensile response via external application of a certain electrical signal to a prehensile body part of the animal. Such electrical signal may have, among other properties, an electrical energy that exceeds a “let-go” threshold. As it is known, a “let-go” threshold is the maximum energy an animal can tolerate and at which the animal can still control the muscles of its prehensile body part with internal electrical signals sufficient to exceed an involuntary prehensile grip. Once the animal can no longer voluntarily let go of the electrode that is delivering external electrical energy to the prehensile body part, the let-go threshold has been exceeded.

In at least some methods described herein, an electric energy in excess of a let-go threshold is used to cause involuntary muscle contractions (i.e., “grasp” or “grip”) in a target rodent. These muscle contractions control the grasp of one or more prehensile body parts of the target rodent, and upon asserting such control, the target rodent is forced to involuntarily grasp a certain structure or substructure such as an electrified wire. This involuntary grasp is used to immobilize the target rodent. In some cases, reduction or removal of electric energy is used to permit release of the target rodent.

Within the devices, systems, and methods discussed in the present disclosure, in at least some cases, a processor may be included to execute instructions stored in a memory and thereby control operations of a rodent abatement system. The innovation described in the present disclosure is new and useful, and the innovation is not well-known, routine, or conventional in the computer-controlled pest eradication industry.

In a first embodiment, an apparatus, includes a chamber, an electrically conductive graspable member, and a power supply. The power supply is coupled to the electrically conductive graspable member and arranged to deliver an electric signal to the electrically conductive graspable member. The electric signal has sufficient energy to exceed a let-go threshold of a target rodent's prehensile body part.

In some cases of the first embodiment, the chamber has a length of at least three inches (3 in.) and a cross-sectional area of at least four square inches (4 sq. in.). In some cases, the chamber has an internal surface that is substantially smooth and generally slippery to a target rodent's paws. Sometimes, the electrically conductive graspable member is arranged as a metal mesh structure.

In these and other cases of the first embodiment, the apparatus also includes an electrode. The electrode is coupled to the power supply and electrically isolated from the electrically conductive graspable member. The power supply is arranged to provide a first electrical potential to the electrically conductive graspable member and a second electrical potential to the electrode. The first electrical potential is different from the second electrical potential. Sometimes, the power supply includes at least one battery. Sometimes, the power supply is arranged to deliver an electrical signal of between about 10 volts and about 50,000 volts. And sometimes, the power supply is arranged to deliver an electrical signal as a pulsed direct current (DC) energy having a pulsing frequency of between about 10 Hz and about 1000 Hz.

In still other cases of the first embodiment, the apparatus also includes a trigger circuit arranged to detect the presence of the target rodent in the chamber. And sometimes, the apparatus includes an attractant platform wherein the chamber has an open proximal end arranged to receive the target rodent into the chamber and a closed distal end, the attractant platform arranged proximate the closed distal end.

In a second embodiment, a method to eradicate targeted rodents includes positioning a chamber at a location accessible to a targeted rodent, the chamber having an electrically conductive graspable member, and providing an electric signal to the electrically conductive graspable member for a selected duration, the electric signal having sufficient energy to exceed the let-go threshold of a target rodent's prehensile body part, the selected duration being at least five-hundred milliseconds (500 msec).

In some cases of the second embodiment, the method further includes baiting an attractant platform, wherein the chamber has an open proximal end arranged to receive the target rodent into the chamber and a closed distal end, the attractant platform arranged proximate the distal end. Sometimes, providing the electric signal to the electrically conductive graspable member occurs after the target rodent is detected in the chamber and determined to be in contact with the electrically conductive graspable member. In some cases, the electric signal has a voltage of between about 10 volts and about 50,000 volts and wherein the electric signal is a pulsed direct current (DC) energy having a pulsing frequency of between about 10 Hz and about 1000 Hz. And in some cases, the target rodent is a gray squirrel.

In a third embodiment, a system includes a chamber having a substantially cylindrical form factor, the chamber made at least in part from a non-conductive material, the chamber having a proximal end, a distal end, and an interior volume that has a substantially smooth surface that is generally slippery to a target rodent's paws, wherein the chamber sized to accept entry of the target rodent at its proximal end; a power supply arranged to produce an electric signal having sufficient energy to exceed a let-go threshold of the target rodent's prehensile body part; an electrode subsystem electrically coupled to the power supply and having at least one graspable electrode, the electrode subsystem positioned at the proximal end of the chamber; and an accessible attractant platform positioned at the distal end of the chamber when the system is deployed.

In some cases of the third embodiment, the chamber has a length of at least three inches (3 in.) and a cross-sectional area of at least four square inches (4 sq. in.), and the chamber, when the system is deployed, is arranged in a substantially vertical alignment relative to the earth, the proximal end being closer to the earth than the distal end. Sometimes, the at least one graspable electrode is arranged as a metal mesh structure. Sometimes, the power supply is arranged to produce the electric signal having a voltage of between about 10 volts and about 50,000 volts as a pulsed direct current (DC) energy having a pulsing frequency of between about 10 Hz and about 1000 Hz.

In these and other cases of the third embodiment, the system includes a trigger circuit arranged to detect the presence of the target rodent in the chamber; and the system also includes a control circuit arranged to count at least one of a number of times the power supply produced the electric signal and the number of times the trigger circuit detected the presence of the target rodent.

These features with other objects and advantages that will become subsequently apparent reside in the details of construction and operation as more fully described hereafter and claimed, reference being had to the accompanying drawings forming a part hereof.

This Brief Summary has been provided to describe certain concepts in a simplified form that are further described in more detail in the Detailed Description. The Brief Summary does not limit the scope of the claimed subject matter, but rather the words of the claims themselves determine the scope of the claimed subject matter.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1A is a schematic of an animal control system;

FIG. 1B is a schematic of a rodent abatement system;

FIG. 2 is a rodent abatement system deployed in an operating theater;

FIG. 3 is a data flow diagram representing a rodent abatement process;

FIGS. 4A-4F are embodiments of prototype rodent abatement systems; and

FIG. 5 is a partial view of a control system of any rodent abatement system of the present disclosure.

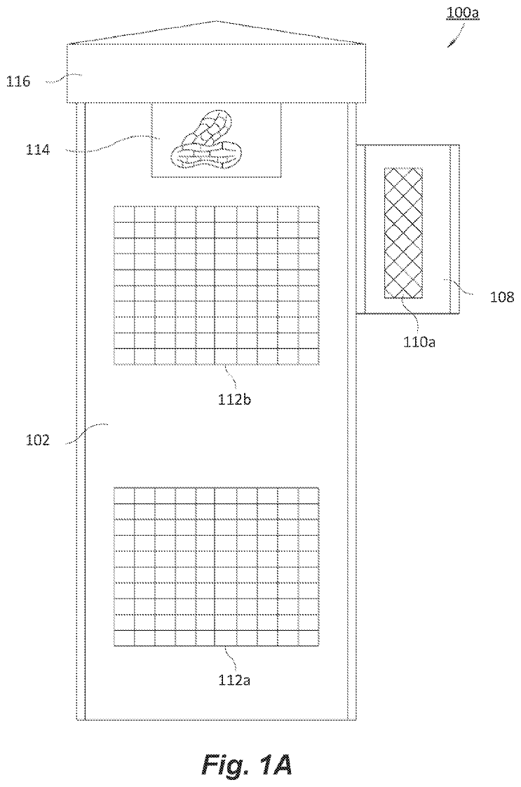

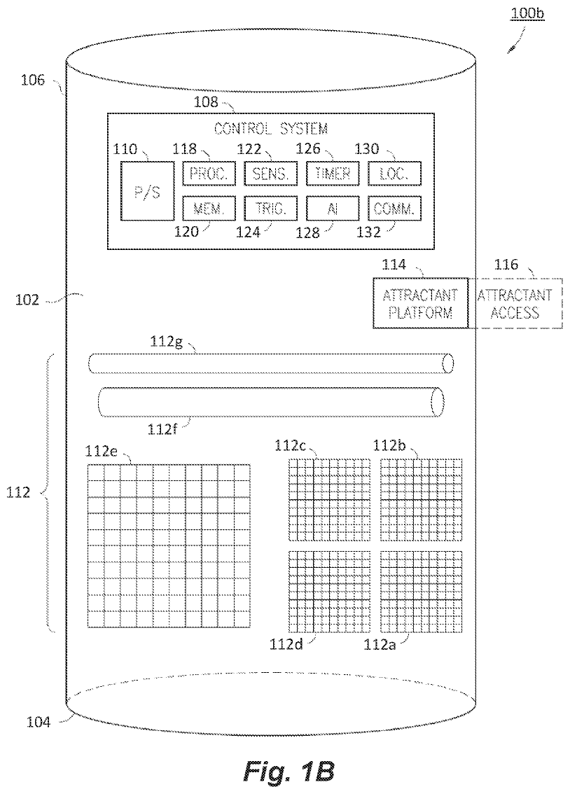

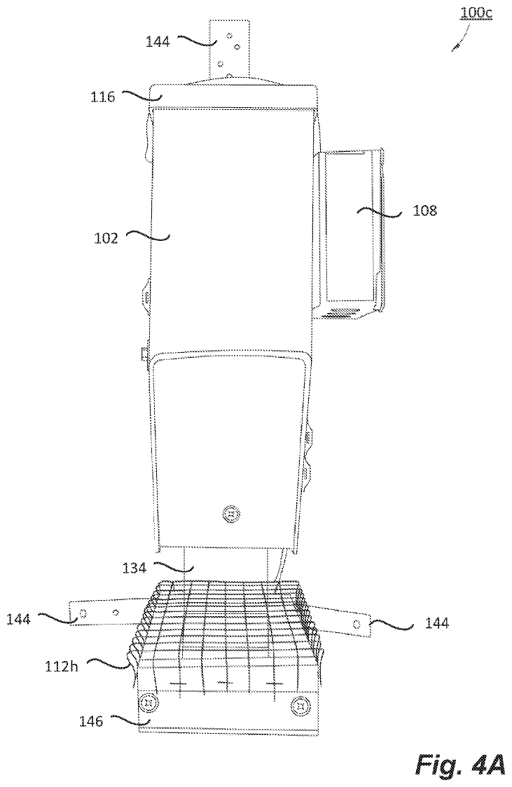

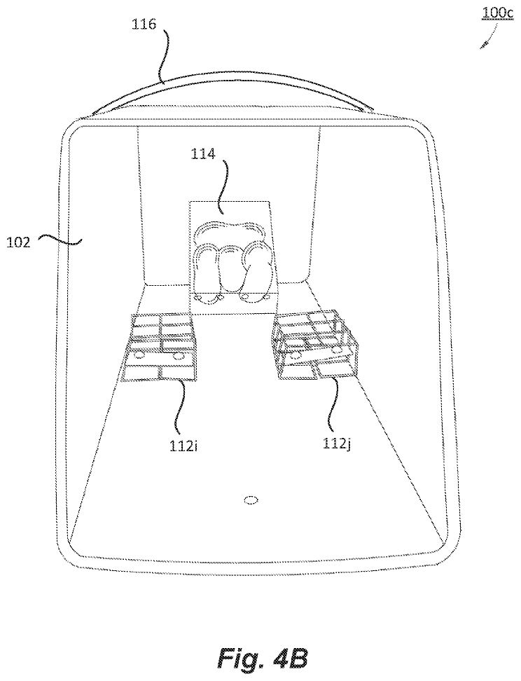

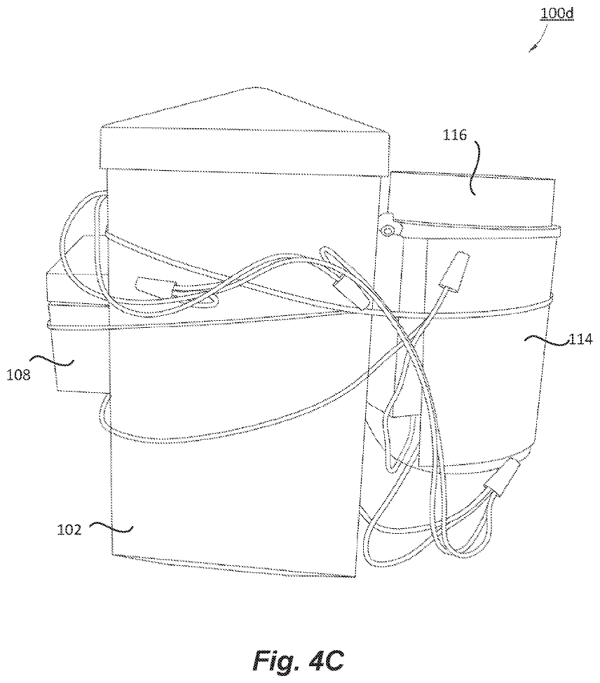

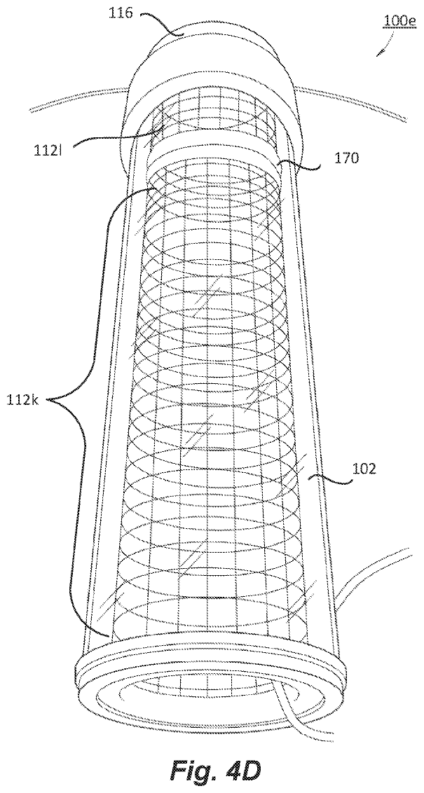

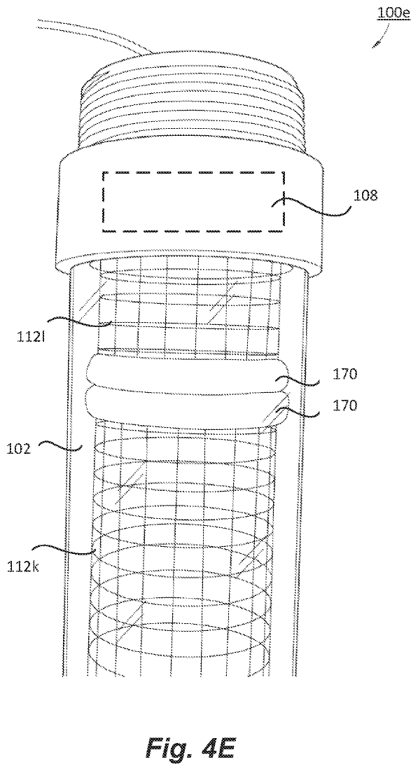

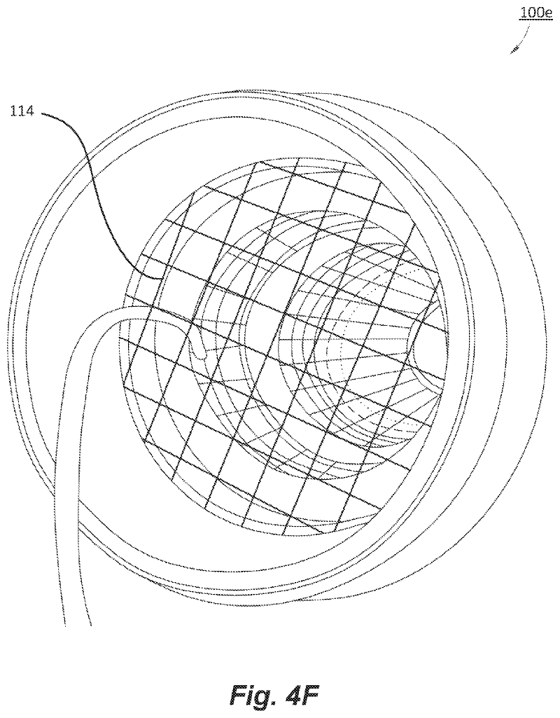

In the present disclosure, for brevity, certain sets of related figures may be referred to as a single, multi-part figure to facilitate a clearer understanding of the illustrated subject matter. For example, FIGS. 1A-1B may be individually or collectively referred to as FIG. 1. For example, FIGS. 4A-4F may be individually or collectively referred to as FIG. 4. Structures earlier identified are not repeated for brevity.

### DETAILED DESCRIPTION

The present disclosure may be understood more readily by reference to this detailed description and the accompanying figures. The terminology used herein is for the purpose of describing specific embodiments only and is not limiting to the claims unless a court or accepted body of competent jurisdiction determines that such terminology is limiting. Unless specifically defined in the present disclosure, the terminology used herein is to be given its traditional meaning as known in the relevant art.

In the following description, certain specific details are set forth to provide a thorough understanding of various disclosed embodiments. One skilled in the relevant art, however, will recognize that embodiments may be practiced without one or more of these specific details, or with other methods, components, materials, etc. Also in these instances, well-known structures may be omitted or shown and described in reduced detail to avoid unnecessarily obscuring more detailed descriptions of the embodiments.

Prior to setting forth the embodiments however, it may be helpful to an understanding thereof to first set forth definitions of certain terms that are used hereinafter.

The terms “abate” and “eradicate,” in all their grammatical forms, are used interchangeably throughout the present specification and claims to refer to reducing or otherwise controlling the local population of a particular rodent. The reduction may be a total reduction of rodents to zero or a reduction of rodents to an acceptable level (e.g., fifty percent (50%) fewer rodents in the local area than before abatement or any other selected percentage or range of percentages, five rodents per acre or fewer in the local area or any other selected number or range of numbers of rodents per selected area size; and the like). The abatement may be inside one or more structures (e.g., house, factory, ship, plane, commercial or residential building, or any other structure), or the abatement may be within a particular boundary such as a park, a farm, a forest, a campus, a golf course, a military base, a pasture, a city, or any other suitable boundary). The local population of the particular rodent may be known, speculated, or unknown. Further still, the eradication may be lethal or non-lethal. That is, abatement and eradication may include any particular type of eradication including, but not limited to, stunning the rodent, immobilizing it, euthanizing or otherwise killing it, rendering it unconscious, restraining it, or the like. In at least one case, eradication of a rodent may refer to temporarily immobilizing a rodent for scientific study, immunization, or other purposes.

The terms “chamber,” “containment chamber,” and the like refer to support structures used in the rodent abatement systems of the present disclosure, which exhibit any suitable extent and shape of enclosure, box, tunnel, screen, shield, cover, or the like arranged to host at least one electrically conductive graspable member of the type described herein. A chamber may be a physical chamber or, in at least some cases, a virtual chamber. That is, a chamber of the present disclosure may define a fully or partially enclosed space of any suitable shape and volume in some cases, and the chamber may not contain any enclosed space at all in other cases. Embodiments of the present disclosure may include one chamber or a plurality of chambers. Embodiments of the present disclosure, with respect to natural earth ground, may include chambers oriented vertically, substantially vertical, partially vertical, horizontally, substantially horizontal, partially horizontal, or in any other suitable orientation to carry out acts of rodent abatement.

The term “electrode” in the present disclosure is an electrically conductive structure or surface that participates in the delivery of electrical energy to a rodent. The electrodes may take any suitable size, shape, configuration, placement, and the like. In many cases, an electrode is an electrically conductive graspable member arranged to deliver electrical energy in excess of a let-go threshold to a targeted rodent for the purpose of eradicating that rodent. In some cases, electrodes are arranged as a metal mesh structure (e.g., wire screening, chicken wire, fencing, electrically conductive hardware cloth, perforated metal sheeting, and the like). In other cases, electrodes are arranged as pipes, rods, nails, wires, plates, pads, sheets, and the like. In the present disclosure, animal control systems and rodent abatement systems include one or more electrodes configured to be grasped by a prehensile body part of a targeted rodent.

The terms “energy,” “electrical energy,” “electric signal,” and the like are used interchangeably throughout the present specification and claims to refer to energy made available by the flow of electric charge through a conductor. In context of the particular use, energy may refer to any one or more characteristics of electromagnetic energy including, but not limited to, voltage, current, power, waveform, frequency, duration, potential, charge, and the like. In at least some cases, secondary characteristics of energy in the present disclosure such as heat, light, sound, radio waves, and the like may also be contemplated.

The term “lifeless” refers to a rodent that is dead, culled, perished, inanimate, exterminated, stunned, unconscious, and the like. When the rodent is lifeless, its carcass (i.e., the rodent's “body” or a substantial portion thereof) may be fully intact or only a partial body.

A “rodent” refers to any animal that possesses prehensile body parts. In particular and without limiting the generality of the foregoing, a rodent in the present disclosure may include any one or more of mice, rats, squirrels, possum, raccoons, beaver, and mustelids. In some cases, moles, skunks, and the like may also be considered rodents despite limited prehensile body parts. A rodent may be further characterized by species, genus, geographic location such as state, country, continent, latitude, and the like. The rodent may be characterized in terms of diet, size, color, behavior, habit, or other characteristics. In at least some but not all cases, a rodent may be characterized in terms of typical undesirable activities that it performs. A non-limiting, non-exhaustive list of undesirable activities performed by rodents contemplated in the present disclosure includes damaging land, damaging or destroying property, carrying disease, depleting a natural resource (e.g., plants, insects, fish, a food source for other species, and the like), overpopulating an area, killing native or desirable plants or animals, and crossbreeding with other species. In other cases, a rodent may be targeted as a food source, a source of pelt, or for other reasons. Accordingly, in some cases, targeted rodents are undesirable, and in other cases, targeted rodents are desirable.

The term “targeted” is used, in all its grammatical forms, throughout the present specification and claims to refer to any rodent that an owner, operator, or other user of the animal control systems described herein desires to be eradicated; and particularly, rodents that are pestiferous, pestilent, pernicious, pestilential, harmful, destructive, ruinous, troublesome, vexing, irksome, detrimental, deleterious, etc.). A pestiferous rodent in the present disclosure is a target rodent or targeted rodent. In some cases, particular rodents are targeted for reasons other then culling, killing, eradication, and the like. In some cases, for example, certain rodents are targeted for capture, removal to another geographic area, for scientific study, for food, for a pelt, for certain anatomical parts, and for other reasons.

Conventional animal traps and conventional control techniques that target particular rodents are largely based on concepts devised at least a century ago. The present inventor has identified several problems associated with these traps and techniques. Many of these conventional traps and techniques involve chemical, biological, physical, or psychological components that are hazardous to humans and non-target species. Most conventional technology traps require high maintenance; for example, frequent service for inspection, re-baiting, carcass (i.e., entire or partial body, alive or dead) removal after each deployment, and resetting. While more recent traps and techniques introduced in the last few decades try to address some of these problems, their results are less than desirable. For example, some repeating traps exist, but they are mechanically complex, and they have limits based on carcass storage, energy source depletion, and the like. Other recent traps and techniques are indiscriminate in their effects. Still others are expensive and difficult to manufacture and use.

Different from the conventional traps and techniques, the device, method, and system embodiments described in this disclosure (i.e., the teachings of this disclosure) enable successful rodent abatement by exploiting the anatomical response of the rodent's prehensile body parts to electrical energy that exceeds a let-go threshold. Various teachings provide improved rodent control devices, methods, and systems that are any one or more of: mechanically simple (e.g., no moving parts, long-service life components, few components, etc.), non-toxic, humane, species-specific, low maintenance, and self-recharging with repeating capture and clearing that is only limited by the effective life of the bait used to lure the rodent. Many embodiments include a tunnel structure, which helps to exclude oversize, undersize, or non-target species. In at least some cases, a weight sensitive switch may be incorporated to limit the energy so that underweight animals are repelled unharmed.

Successful operation of the embodiments described herein to eradicate targeted animals rely on a particular anatomical property common in animals capable of climbing plants, trees, and the like. Typically, animals that climb possess prehensility (i.e., prehensile body parts).

As it is known, prehensility includes the ability to grasp. The human hand is prehensile. Many animals have body parts that possess or contribute to prehensility. Such body parts may include, but are not limited to, hands, fingers, toes, paws, phalanges, tails, claws, jaws, tongues, and the like. Animals with prehensile body parts include, but are not limited to, primates, rodents, mustelids, possums and other phalangers, and some reptiles. In parts of the world, at least some of these animals are considered to be targets for eradication because they are pests or for other reasons. Animals capable of climbing typically possess prehensility.

It is well-known that electrical signals of the nervous system inside the body of the animal are used to control and operate the muscles of the animal's prehensile body parts. And it is further well-known that certain electrical signals outside of the animal's body can override (e.g., exceed, overwhelm, overpower, overcome, swamp, drown out, etc.) the internal electrical signals. In this circumstance, such as when holding an electrode with the hand or paw, for example, if an externally applied electrical energy is sufficient, there comes a time when the subject holding the electrode cannot let go of the electrode. He is said to freeze to the circuit. The maximum energy a person or other animal can tolerate and at which he can still release the electrode by using the muscles directly stimulated by his internal electrical signals is called the “let-go” energy or a let-go threshold.

Electric energy in excess of the let-go threshold will have a similar effect on any prehensile body part where the flexor muscles, which cause the animal to grasp, overpower the extensor muscles, which permit the animal to let go. In other words, sufficient electrical stimulation applied outside the animal will cause the animal to involuntarily grasp, and if the object being grasped is the source of the outside electrical stimulation, the animal will be unable to command its body to release the object.

FIG. 1A is a schematic of an animal control system 100a, and FIG. 1B is a schematic of a rodent abatement system 100b. In some cases, the animal control system 100a of FIG. 1A further includes the structures of the rodent abatement system 100b of FIG. 1B. In some cases, the rodent abatement system 100b of FIG. 1B only includes the structures of the animal control system 100a of FIG. 1A. To avoid unnecessarily confusing one of skill in the art, in the present disclosure, either or both of the animal control system 100a and the rodent abatement system 100b of FIG. 1B may be referred to herein as animal control system 100 or a rodent abatement system 100.

The animal control system 100a is particularly arranged to cull gray squirrels (FIG. 4C). Other rodents are of course contemplated, and one of skill in the art will recognize that the embodiment of FIG. 1A is presented to clearly and simply present at least a portion of the inventive content illustrated and described in the present disclosure.

In the animal controls system 100a, a chamber 102 is arranged as a tube or tunnel possibly formed of a conventional plastic pipe or other like structure having an inside diameter of between about two inches and about eight inches (about 2 in. to 8 in.). In at least one case, the pipe has an inside diameter of between about three inches and about four inches (about 3 in. to 4 in.). The chamber 102 of FIG. 1A is shown as a longitudinal cross section wherein structures arranged in the interior of the chamber can be seen.

The chamber 102 of FIG. 1a is formed of an electrically non-conductive material such as polyvinylchloride (PVC), acrylonitrile butadiene styrene (ABS), or some other material. Chamber 102 is desirably sized to exclude non-target animals. In the present case, for example, the chamber 102 is formed as a tunnel that will generally exclude animals that are not gray squirrels in the present example. Exclusion of non-target animals may also be accomplished by trap location.

Electrodes 112a, 112b are electrically coupled to a control system 108. The electrodes 112a, 112b in FIG. 1a are formed of a metal mesh that is graspable by a gray squirrel's or other targeted rodent's prehensile front paws and feet. In other embodiments, one or another of electrodes 112a, 112b may be formed of a metal mesh and others of the electrodes may be formed by a planar electrically conductive material such as a metal sheet or plate. At least one of the plurality of electrodes has a form that can be grasped by the target animal.

Control system 108 is arranged as a generally weatherproof enclosure that houses a power supply (e.g., a rechargeable battery, a switching power supply), an optional solar cell 110a, and certain electronics arranged to generate electrical energy in excess of the let-go threshold of the gray squirrel when the animal contacts both electrodes 112a, 112b for a time prescribed to euthanize the squirrel (e.g., about five to one hundred twenty seconds (about 5 sec to 2 min.) in some cases; about 20 to 90 seconds in at least one case). Additional sensors may be arranged in the control system 108 to detect an animal, to repel non-target animals (e.g., with a reduced energy pulse, with flashing or other light, with particular sounds, and the like), to count a number of times the electrodes 112a, 112b were electrified, and other sensors.

An attractant platform 114 is arranged to hold an attractant (e.g., a bait of any suitable type) to lure a target animal (e.g., gray squirrels in the present example). The attractant platform 114 may be formed of wire, screen, clear plastic with apertures, or some other materials. In at least some cases, the attractant platform 114 permits a visual, essential, auditory, or other like attractant to lure a gray squirrel into a position of contacting at least two electrodes that activate the electrical energy. Nuts of one type and kind or another have been learned to be an effective attractant for gray squirrels.

A tunnel cap is arranged as an attractant access portal 116 to prevent entrance to the chamber 102 from above and to suspend the attractant platform 114 for easy maintenance.

In at least one exemplary operation of the animal controls system 100a, chamber 102 is suspended in a lengthwise vertical orientation from an exterior wall, a tree, a post or some other structure at a height and circumstance that makes the bottom end (e.g., the open end, the proximal end, the end closest to the ground, or the like) of the chamber 102 accessible to a gray squirrel. The tunnel cap (i.e., attractant access portal 116) is separated from the pipe (i.e., chamber 102), and an attractant such as peanuts or peanut butter is applied to the attractant platform 114. The tunnel cap is restored to its position on the top end (e.g., the closed end, the distal end, the end furthest from the ground, or the like). A charged battery is deployed in the control system 108, and subsequently, a gray squirrel enters the bottom end of the chamber 102, presumably to reach the attractant.

At some point in the exemplary operation, when the gray squirrel is climbing one or more of the electrodes 112a, 112b, an electrical signal that exceeds the let-go threshold of the squirrel is delivered to the squirrel via the electrodes 112a, 112b. Electrical energy may flow from one or both front paws in contact with the upper grid electrode 112b, through the body and leg or legs of the squirrel to its foot or feet, which are in contact with the lower grid electrode 112a. The electrical energy passing through the muscles located in the squirrel's forearm or forearms cause the front paw or paws to involuntarily increase its or their grasp on the upper grid electrode 112b. The energy passing through the squirrel's lower leg or legs has the same effect on the foot or feet. The squirrel, unable to release its prehensile grip, is culled. The squirrel's death is caused by the freezing effect of electrical energy on the muscles of the heart and lungs, thereby inhibiting respiration and blood flow. Lack of oxygen to the brain results in rapid and humane unconsciousness and, if the charge is maintained for sufficient duration, death.

After a determined period of time, the electrical energy is removed. At some point in time after the electrical energy was applied, the gray squirrel releases its grasp of the electrodes 112a, 112b, and the lifeless squirrel drops from the chamber 102. Sometimes, the squirrel falls after the electrical energy is removed from the electrodes 112a, 112b thereby removing the cause for the squirrel's involuntary grasp. In at least some other cases, however, the squirrel falls before the electrical energy is removed when its muscles fatigue and become unable to grasp hard enough to support the squirrel's weight.

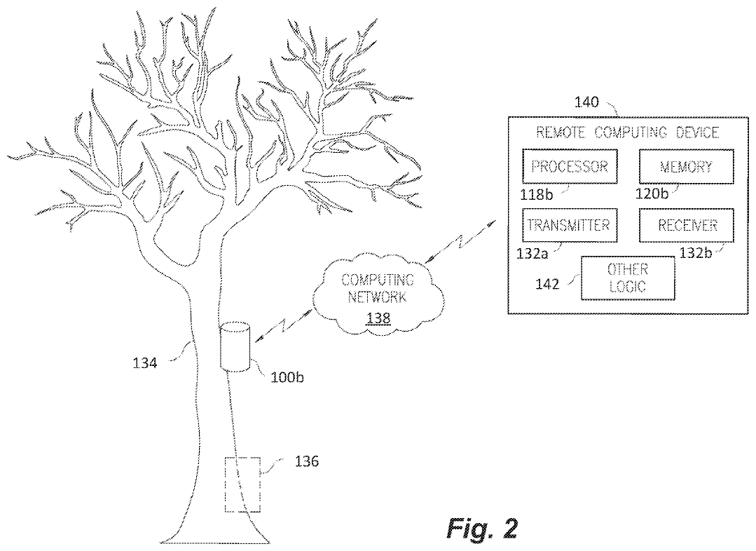

FIG. 1B is a schematic of a rodent abatement system 100. The system 100b includes a chamber 102 that has a first end 104 and a second end 106. One end of the chamber 102 may be a proximal end, and the other end may be a distal end. In the embodiment of FIG. 1, the proximal end is open. In other embodiments, the distal end is open to receive a targeted rodent and the proximal end is closed to collect the carcass of the eradicated rodent (FIG. 2). Contained within the interior volume of the chamber 102 is a control system 108, a power supply 110, a set of electrodes 112, and an attractant platform 114. The attractant platform is arranged to be serviced via an attractant access portal 116. In some cases, the attractant access portal 116 is arranged in a sidewall of the chamber 102. In other cases, the attractant access portal 116 is arranged at the distal end of the chamber 102. Other placements of an attractant access portal 116 are also contemplated.

The control system 108 of the rodent abatement system 100 of FIG. 1 includes any suitable number of modules. The control system 108 may include electronic modules, electromechanical modules, and mechanical modules. Some modules are included in all embodiments, and some modules of the control system 108 are optional or included only in some embodiments. In at least some cases, with respect to complex software for example, one or more modules may be included but not necessarily enabled. Access to these optional modules may be enabled via payment, subscription, permission to access data, or the like. In the embodiment of FIG. 1, modules of the control system 108 include a power supply 110, a processor 118, memory 120, sensor logic 122, trigger logic 124, timer logic 126, a complex computing engine 128, (e.g., artificial intelligence (AI), machine learning (ML), machine vision, augmented vision, edge computing, or the like), a location determination circuit 130, and communications circuitry 132.

The chamber 102 in the embodiment of FIG. 1, for example, has a substantially cylindrical form factor made at least in part from a non-conductive material. The non-conductive material provides electrical isolation of the electrodes. In some cases, for example, the chamber 102 is formed from a section of two-inch diameter poly-chloride vinyl (PVC) pipe. Other shapes, sizes, and materials are of course contemplated. With respect to shape, for example, the cross-sectional shape of chamber 102, when cut across the dimension having the longest length, may be a circle, a square, a rectangle, a pentagon, a hexagon, an octagon, or any other suitable regular or irregular shape. With respect to materials, chamber 102 may be formed from a single material or a plurality of materials, and chamber 102 may be formed, at least in part, from any one or more of a plastic, a rubber, a metal, a wood, a composite, or any suitable organic or inorganic material. Chamber 102 may include any extent of containment in the form of an enclosure, box, tunnel, screen, shield, cover, or the like.

In at least one instance, chamber 102 of the rodent abatement system 100 of FIG. 1 is about four-to-six inches long and cut from a piece of ordinary PVC plumbing pipe. Two sections of metal mesh fencing (e.g., galvanized steel hardware cloth, welded wire farm fencing, or the like) form electrodes 112c-112g and an attractant platform 114 are arranged inside the chamber 102. When the chamber 102 is mounted in a substantially vertical orientation wherein the first end 104 is closer to the ground than the second end 106, the attractant platform 114 is located above the electrodes 112 (i.e., the metal mesh fencing sections). In this orientation, the vertical orientation of the chamber 102 permits a rodent to enter the proximal opening at the first end 104 and climb the fencing inside the PVC pipe chamber 102 to reach “food” placed on the attractant platform 114. At least one first section of metal mesh fencing is arranged as a first electrode 112 electrically coupled to a positive terminal of the power supply 110, and at least one second section of metal mesh fencing is arranged as a second electrode 112 electrically coupled to a negative terminal of the power supply 110. When the rodent climbs the metal mesh fencing inside the chamber 102, an electrical energy that exceeds the rodent's let-go threshold sourced from the power supply 110 flows through the rodent's body, and when the rodent is lifeless, it will fall from the chamber 102 having never reached the attractant (e.g., bait, food, lure, or some other attractant) on the attractant platform 114. Notably, the interior volume of the PVC chamber 102 is at least partially electrically non-conductive, and the inside surface of chamber 102 is smooth and generally slippery to a rodent's paws. In such embodiments, the only (or easiest) way for the rodent to reach the attractant is to climb the metal mesh fencing electrodes 112 inside the chamber 102, and when it climbs, the rodent is eradicated by electrocution.

Non-targeted animals (e.g., humans, birds, certain rodents, and the like) avoid injury by the rodent abatement system 100 in several ways. For example, injury is avoided because the electrified apparatus is fully contained within the chamber 102. Injury is also avoided by non-targeted species because the dimensions of chamber 102 and its components may be selected to discriminate based on size, the attractant selected, the amount of energy delivered to the electrodes 112, and the like. More specifically, a chamber 102 sized appropriately for a target species will not permit entry by a larger species, and a control system 108 (e.g., power supply 110, sensor module 122, and trigger module 124) appropriately configured for the target species will deliver non-lethal deterrent energy (e.g., an energy pulse reduced in energy, duration, or some other characteristic) to repel a smaller species. Generally speaking, with configuration, placement, and baiting appropriate to the target species, a rodent abatement system 100 of the present disclosure can be configured to target any animal with prehensile paws and exclude or repel non-target animals via, for example, its installation (e.g., height above ground), size of the opening at the first end 104 of the chamber 102, arrangement of the electrodes 112, use of a particular attractant, and other exclusion methods.

Various modules of the control system 108 are now described. In some cases, all modules of the control system 108 are contained within a single housing. The control system 108 is represented in FIG. 1 as contained within the chamber 102, but in some cases, the entire control system 108 or various modules of the control system 108 are located outside of the chamber 102. In at least some cases, such as when the power supply 110 is a battery for example, the control system 108 may be arranged in a standardized housing that allows for quick removal and replacement. In such a case, an operator of the rodent abatement system 100 may service the system on a certain schedule by visiting any number of deployment sites and replacing a control system 108 having a depleted power supply 110 battery with a control system 108 having a power supply 110 battery of sufficient or otherwise greater charge.

Power supply 110 may be configured in any particular way for any particular location and to eradicate any particular rodent. In at least one embodiment, power supply 110 is arranged to provide between about 10 volts and about 50,000 volts (e.g., about 50 volts to 15,000 volts in some cases, and about 6000 volts in at least one case) between two electrodes 112 after a rodent is detected in chamber 102. In this and other cases, a current generated by the power supply 110 may be a pulsed direct current (DC) energy produced at a pulsing frequency of between about 10 Hz and about 1000 Hz (e.g., about 20 Hz to 250 Hz in some cases, and about 25 Hz in at least one case). Other power supply circuits are contemplated. Energy having other characteristics being produced by power supply 110 is also contemplated.

In some cases, power supply 110 includes a charge storage device. The charge storage device may be a battery, a capacitor, a super capacitor, or any other charge storage device or combination of devices. In at least one case, power supply 110 includes a six-volt sealed lead acid absorbent glass mat (AGM) type battery.

In some cases, power supply 110 includes at least one photovoltaic energy conversion structure. The photovoltaic energy conversion structure may be configured as a solar cell, a solar panel, a solar array, a device arranged to receive beamed light (e.g., laser light), or some other such device. The photovoltaic energy conversion structure may be used to charge a battery or other energy storage device. In some cases, the photovoltaic energy conversion structure may provide power to operate other electric or electronic circuits of the control system 108.

In still other cases, the power supply 110 may include an energy conversion circuit that harvests energy based on at least one of motion, vibration, wind, flowing water, heat, chemical combustion, nuclear reaction, and ambient electromagnetic energy.

As described herein electrodes 112 are electrically coupled to the power supply 110. The electrodes in the present disclosure may take any suitable size, shape, configuration, placement, and the like that is, or are, graspable by a target rodent. In at least one embodiment, electrodes 112 are arranged as contact pads of a conventional galvanized steel hardware cloth (e.g., metal mesh). With respect to the delivery of electrical energy to prehensile body parts of a rodent, only two electrodes 112 are required, at least one of which is graspable by the rodent, but more than two may be employed if advantageous.

In the rodent abatement system 100, various electrodes 112 are represented, but these electrodes 112a-112g are not limiting, and other electrode structures (e.g., pads, surfaces, contacts, and other shapes, sizes, and design) are of course contemplated.

Electrodes 112a-112e are arranged as a grid made, for example, of electrically conductive metal mesh or some other material in some other pattern that is graspable by a target rodent. Rather than squares, for example, electrodes 112a-112e may be arranged having “holes” that are diamond-shaped, hexagonal, circular, or some other regular or irregular shape. The diameter of the wire made to form electrodes 112a-112e may be about between about 20 mils (0.020 inches) and about 125 mils (0.125 inches) in diameter, but other diameters are contemplated. The electrodes 112a-112e may be formed as a square, a rectangle, or in any other suitable shape. In some cases, electrodes 112a-112e have one or more linear dimensions between about one inch (1 in.) and about four inches (4 in.) in length. Such dimensions may be suitable to eradicate mice, rats, possum, raccoons, squirrels, and other rodents.

Electrode 112f is arranged as a metal rod, and electrode 112g is arranged as a metal wire, either or both of which is graspable by a target rodent. These electrodes 112f-112g, may be straight, curved, looped, or arranged in any other suitable shape. Such electrodes 112f-112g may be sized for one or more particular targeted rodent species. In some embodiments, electrodes 112f-112g are between about 60 mils (0.060 inches) and about 500 mils (0.50 inches) in diameter and between about one inch (1 in.) and about four inches (4 in.) in length. Such dimensions may be suitable to eradicate mice, rats, possum, raccoons, skunk, squirrels, and other rodents.

Attractant platform 114 is optional. In some cases, for example, abatement techniques include an un-baited chamber 102 (e.g., a chamber that is absent any attractant and may be absent any attractant platform). One exemplary case includes an apparatus that functions to abate targeted rodents as described herein, which is coupled proximate to horizontal or substantially horizontal pipes that rodents use as pathways. In embodiments of such case, an optional attractant may be excluded, an optional attractant platform may be excluded, or both an attractant and an attractant platform may be excluded.

When it is included, attractant platform 114 may be arranged of any suitable material in any suitable configuration. The attractant platform will hold a suitable attractant (e.g., bait, food, lure, or the like) intended to attract the species of rodent targeted for eradication. When deployed, the attractant platform 114, is positioned in the interior volume of the chamber 102 at or near the second end 106. The attractant provided on the attractant platform will only be accessible to a rodent that ventures into the interior volume of chamber 102 and not accessible to the rodent from outside the chamber 102. When deployed, for example, an attractant on the attractant platform 114 may be deposited via attractant access portal 116, which is then sealed. In at least one case, for example, when chamber 102 is formed having a substantially cylindrical shape, the distal second end 106 of the chamber 102 is threaded or includes another temporary or fixed securing method (e.g., clips, hook-and-loop material, pins). The attractant access portal 116 in such embodiment is the open second end 106 of the chamber 102, and after an attractant is provided on the attractant platform 114, a cooperatively threaded cap is used to cover the distal second end 106 of the chamber 102.

In some cases, attractant platform 114 is arranged to receive an attractant having a standardized form factor. In this way, servicing a rodent abatement system 100 may be performed by simply removing an expended attractant from the attractant platform 114 and replacing it with a fresh attractant. Such fresh attractant may be readily available to service providers.

Processor 118 is a processing device of any suitable form, structure, size, and operation. Processing devices, or “processors,” as described herein, include central processing units (CPU's), microcontrollers (MCU), digital signal processors (DSP), application specific integrated circuits (ASIC), peripheral interface controllers (PIC), state machines, and the like. Accordingly, a processor as described herein includes any device, system, or part thereof that controls at least one operation, and such a device may be implemented in hardware, firmware, or software, or some combination of at least two of the same. The functionality associated with any particular processor may be centralized or distributed, whether locally or remotely. Processors may interchangeably refer to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory or may be hard-coded as a state machine or set of control signals. According to methods and devices referenced herein, one or more embodiments describe software executable by the processor, which when executed, carries out one or more of the method acts.

Memory 120 is a memory of any suitable form, structure, size, and operation. As known by one skilled in the art, a computing device such as control system 108 has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory. The memory in some cases is a non-transitory computer medium configured to store software instructions arranged to be executed by a processor. Some or all of the stored contents of a memory may include software instructions executable by processor 118 or some other processing device to carry out one or more particular acts.

The sensor subsystem 122 may comprise any suitable number and type of sensor. In many cases, one or more sensors may be arranged as part of a detection circuit to generate a simple determination that a rodent is in chamber 102. In these or other cases, any number and type of sensors may be used to generate a determination that the rodent has its paws in contact with two or more electrodes 112, which subsequently deliver a suitable eradicating charge.

In at least some cases, one or more sensors of a sensor subsystem 122 are arranged as sensing circuitry. The sensing circuitry may include a resistive switch that stands alone or is coupled to one or more electrodes 112. In this way, a high energy output may share the same electrodes to provide sufficient contact for eradication even before the energy from power supply 110 is activated.

The rodent abatement system 100 of the present disclosure may include camera sensors, weight sensors, temperature sensors, humidity sensors, light sensors, sound sensors, gas flow sensors, and a sensor arranged to detect any one or more properties. In at least one case, a camera sensor may be coupled to image recognition logic to determine when a rodent is present in the chamber 102. Camera sensors may of course be used in many other ways.

In at least one case, one or more load cells are configured as a weight sensor to determine the presence of a rodent by “weighing” an object, presumably a targeted rodent if the determined weight falls within a selected range for such rodents. Data generated by one or more load cells may be used to determine if a rodent is alive or dead. Data generated by one or more load cells may be used to determine if an object or animal in the chamber 102 is a target rodent.

Other sensor logic that may be deployed as or within a sensor subsystem 122 may include a motion sensor logic (e.g., infrared (IR) source and IR detection, a photocell, a camera, or the like), temperature sensor logic, light sensor logic, color sensor technology (e.g., filters), humidity sensor logic, gas flow sensor logic, a microphone, or any other sensor technology.

The trigger module 124 may be used to detect the presence of a rodent in some cases, and the trigger module 124 may be additionally or alternatively used in some cases to commence energy flowing to one or more electrodes 112. In at least one case, the trigger module 124 is a resistive switch. In such cases, the resistive switch may be coupled to one or more electrodes 112.

In some embodiments, the trigger module 124 includes one or more components of the sensor subsystem 122. For example, a trigger module 124 may include contacts, one or more loadcells, a camera, a motion sensor, a motion sensor, or any other suitable detection sensor.

A timer module 126 of the control system 108 may include any suitable number of clock circuits. A first timer may be used to delay application of an eradication-level of energy to electrodes in some cases (i.e., a level of energy that exceeds the targeted let-go threshold). For example, after detection of a rodent, a timer may delay one-half second, one second, two seconds, or some other delay period to allow the rodent to advance into the chamber 102 and grasp one or more electrodes 112 with its paws before the energy is applied. In these and other cases, a second timer may be used to control how long an eradication-level energy is applied to electrodes 112. Timer circuitry may be used for any other suitable purposes including, but not limited to, setting time for on, off, or on and off activation of the rodent abatement system 100, setting time for servicing the chamber 102, and setting time before reporting one or more parameters of the rodent abatement system 100. Other uses for timers are of course also contemplated.

The complex computing engine 128 may be entirely located in memory 120 within the control system 108 in some cases. In other cases, some or all of the complex computing engine 128 may be located remotely (e.g., on a remote computing server 140 (FIG. 2)). The complex computing engine 128 may include any one or more of artificial intelligence logic, machine learning logic, machine vision logic, neural network, or other such complex computing algorithms.

The complex computing engine 128, when deployed, may process data from any suitable type or any number of sensors of the sensor subsystem 122 including, but not limited to, camera or other imaging sensors, motion sensors, weight sensors, temperature sensors, and the like. In some cases, the complex computing engine 128 is arranged to determine that a rodent of suitable size is present in the chamber 102. In other cases, the complex computing engine 128 may analyze sensor data to determine and discriminate between a target rodent and a non-target animal or other object. Along these lines, the complex computing engine 128 may be used to analyze and generate a probability factor based on size, weight, image recognition, color recognition, mannerisms of a target rodent's motion, pattern matching, temperature, sound, or any other such characteristic. The probability factor generated by the complex computing engine 128 may be a level of confidence that a detected object in the chamber 102 is a target rodent. In at least some cases, if the probability factor crosses (e.g., meets, exceeds, falls below, or meets some other measure) a determined threshold, then energy will be permitted to flow to the electrodes 112, and the object (e.g., a determined target rodent) will be eradicated. In at least some cases, the determined threshold is manually or computationally controllable. In these or other cases, the determined threshold may be fixed. In still other cases, the determined threshold may be automatically adjusted based on time of day, season of the year, amount of charge or other factors of the power supply 110, frequency of deployment (e.g., how often the chamber 102 is being filled by targeted rodents that are eradicated and cleared), or any other desired parameters.

In at least some cases, the complex computing engine 128 may be used to determine a time factor. Certain time factors may include how much time should pass after detection of a rodent before the electrodes 112 are energized, how long the energy should be applied to the electrodes 112, how long the rodent abatement system 100 can operate between servicing, useful life of a particular attractant, or other time factors.

In some cases, the complex computing engine 128 can also be used to determine effectiveness of the rodent abatement system 100. The effectiveness can be based on data collected from a single rodent abatement system 100 or a plurality of rodent abatement systems 100. An effectiveness factor can be generated from any type of data including, but not limited to, geography, time of day, season of the year, temperature, humidity, type of attractant, freshness of the attractant, volume of attractant, or any other factor. In these or other cases, an effectiveness factor can be generated for various portions of the rodent abatement systems 100 such as type of graspable electrodes 112, placement or positioning of graspable electrodes 112 within a chamber 102, dimensions of the chamber 102 or other structures, and the like.

In some cases, training data may be used to initialize the complex computing engine 128. The training data may be any useful training data set. For example, it has been recognized that rodent abatement systems 100 as embodied, for example, in FIG. 1, may collect data from a large number (dozens, hundreds, thousands) of eradications. The collected data may be from rodent abatement systems 100 in the same geographic area or from widely disparate geographic areas. Some or all of the data collected from any number of rodent abatement systems 100 may be used to improve the quality of the complex computing engine 128. Based on the collected data, patterns for any given rodent abatement may be formed, and data received from a particular rodent abatement system 100 may be analyzed against the selected pattern. A determination can then be made, for example by a remote computing server 140 (FIG. 2), whether or not additional action should be taken, whether or not any parameters should be adjusted, whether or not any communications or alerts should be issued, or any other acts should be performed.

Location determination circuit 130 is optional. The location determination circuit 130 is arranged to generate location information associated with the chamber 102.

The location determination circuitry 130 may include global positioning system (GPS) circuitry, global navigation satellite system (GLONASS) circuitry, BeiDou navigation satellite system circuitry, cellular system triangulation circuitry, or some other location determination circuitry. The location determination circuitry 130 may be a self-contained module, or the location determination circuitry 130 may include antennas, amplifiers, transceivers, or other components distributed elsewhere in the chamber 102 or external to the chamber 102. The location determination circuitry 130 permits the rodent abatement system 100 to accurately report its position to another computing device such as a remote computing server 140 (FIG. 2). In some cases, the position may be used to positively identify the particular rodent abatement system 100 embodiment and distinguish data from the rodent abatement system 100 of FIG. 1 from other rodent abatement systems deployed in other locations. In some cases, the position may be used to expressly direct service personnel to the site where the rodent abatement system 100 is installed. The position information can be used diagnostically when a rodent abatement system is determined to be failing, when a sensor crosses a particular threshold or determines some other sensor information, when an attractant platform 114 is ready for re-fill, and for other reasons. The highly accurate time-base of the location determination circuitry 130 may also be used by the rodent abatement system 100 for weather data, almanac data, signal triangulation with other devices such as rodent abatement systems, lighting controllers, motor vehicles, smart computing devices (e.g., smart phones, tablet computers, portable computers, wearable devices, or the like) or some other device and for other purposes.

The communications circuitry 132 may include any suitable wired, wireless, or wired and wireless communication circuits. For example, in some cases, the communications circuitry 132 includes optical electronic circuitry to communicate information via a fiber-optic cable. In some cases, the communications circuitry 132 includes network circuitry (e.g., Ethernet transceivers) to communicate via electrically conductive wire. In still other cases, the communications circuitry 132 includes powerline communications circuitry to communicate via a power line such as when the rodent abatement system 100 is deployed one or near a power pole, in a barn, or otherwise along these lines. In these or yet other embodiments, the communications circuitry 132 may include a wireless transceiver module to provide wireless communication capability via WiFi, cellular communications, direct peer-to-peer RF communications, or via some other wireless communication protocol. Among other things, the communications circuitry 132 can be used to receive control information to configure the rodent abatement system 100, and additionally or alternatively, the communications circuitry 132 can be used to transmit data (e.g., generated data, collected, data, or any other data) from the rodent abatement system 100. The data may include location information, identification information, operational state, power supply (e.g., battery) condition, and the number of eradication cycles performed. Other data sent to or from the rodent abatement system 100 has also been contemplated.

FIG. 2 is a rodent abatement system 100b deployed in an operating theater. The rodent abatement system 100b is along the lines of the rodent abatement system 100 of FIG. 1. The chamber 102 of the rodent abatement system 100b is permanently or removably coupled in a substantially vertical orientation to a base station 134. In the embodiment of FIG. 2, the base station is a tree, but in other embodiments, a base station 134 may be a wall, a post, a pole, a fence, an internal or external wall, or any other structure suitable to host a chamber 102. An additional natural or artificial climbing structure 134b may be arranged about the chamber 102 to facilitate a target rodent's entry into the chamber 102. In FIG. 2, climbing structure 134b is the surface (e.g., bark, trunk) of a tree, but in other cases, the climbing structure may be a wire, a cable, a fence, a platform, a ramp, or any other suitable climbing structure. The base station may be indoors, outdoors, in a covered area, or fully exposed to the outdoor elements.

Mounting the rodent abatement system 100b to the base station 134 may be accomplished by any means. For example, the chamber 102 or some other part or parts of the rodent abatement system 100b may be coupled to the base station 134 by one or more straps, screws, nails, hooks, or the like. Additionally, or alternatively, all or part of the rodent abatement system 100b may be coupled to the base station 134 by tape, glue, or some other adhesive. Still other mounting means are also contemplated.

The rodent abatement system 100b is deployed in communicative proximity to a computing network 138. That is, in at least some embodiments, communications between a communications circuit 132 of the rodent abatement system 100b and one or more other devices is performed via a computing network 138.

A computing network 138 facilitates bidirectional, unidirectional, or bidirectional and unidirectional communications between any number of computing devices. In some cases, any number of rodent abatement systems 100b may communicate with any number of other rodent abatement systems 100b and any number of other computing devices. Communications with and between rodent abatement systems 100b and any type of computing devices may be peer-to-peer, broadcast, or via a central computing device such as a remote computing device 140.

The computing network 138 may include optical electronic circuitry, fiber-optic cable, network circuitry (e.g., Ethernet transceivers), electrically conductive wire, powerline communications circuitry, wireless transceiver circuitry (e.g., WiFi, cellular communications circuitry, any other radio frequency (RF) circuitry, audible communications circuitry, sub-audible communications circuitry, and the like).

In the embodiment of FIG. 2, data representing any desirable type of information is communicated between at least one rodent abatement system 100b and a remote computing server 140. In some cases, data representing any desirable type of information is communicated between at least one rodent abatement system 100b and one or more other rodent abatement systems 100c, 100d, 100n.

The remote computing server 140 includes various components such as a processor 118b, memory 120b, a transmitter 132a, a receiver 132b, and other logic 142. The receiver 132b of the remote computing device 140, or other rodent abatement systems 100c, 100d, 100n, may receive a single message or a plurality of messages from a rodent abatement system 100b. In some cases, the messages include a system-wide unique identifier of the rodent abatement system 100b, location information, alert information, usage/triggering information, sensor data, one or more images (i.e., a single image or a stream of images) or any other desirable data.

In some cases, processor 118b may be arranged to process data received from the rodent abatement system 100b. In some cases, the processor 118b is arranged to perform whole or partial complex computing algorithms. Processor 118b may be along the lines of processor 118 of FIG. 1 in some cases, and in other cases, processor 118b has a different configuration.

Memory 120b may store data received from one or more rodent abatement systems 100b. Memory 120b may store control information or other data to be transmitted to one or more rodent abatement systems 100b. Additionally, or alternatively, memory 120b be arranged to include computer-executable instructions which are executable by processor 118b. Memory 120b may be along the lines of memory 120 of FIG. 1 in some cases, and in other cases, memory 120b has a different configuration.

Transmitter 132a may transmit one or more messages to any number of rodent abatement systems 100b, 100c, 100d, 100n. The messages may include control information such as parameters to direct operations of any circuits of the sensor subsystem 122. In at least some cases, transmitter 132a is arranged to transmit alert information, operational information, or any other data from the remote computing server 140 to another computing device. In this way, service personnel or others may understand the operation of a rodent abatement system 100b, 100c, 100d, 100n and/or control the operations of a rodent abatement system 100b, 100c, 100d, 100n in real time.

A non-limiting, and non-exhaustive list of parameters that can be set in a rodent abatement system 100b, 100c, 100d, 100n include delivered energy (e.g., voltage, current, power, frequency, waveform, and the like), timing information, hours of operation, and the like. A non-limiting, and non-exhaustive list of data that can be sent from one or both of a rodent abatement system 100b, 100c, 100d, 100n and a remote computing device 140 include the number of eradications performed, power supply information (e.g., energy delivered to the graspable electrodes 112, amount of charge remaining in a battery, and the like), image data from a camera sensor, alert information, fault information, and the like.

Embodiments of the remote computing device 140 include other logic 142 that may include any suitable circuitry, executable software, data, and other logic. In some cases, for example, the other logic 142 includes, but is not limited to, web server functionality, database functionality, security logic (e.g., hardware, software, or hardware and software arranged to perform encryption/decryption, obfuscation, or other data protection operations), parallel processing, one or more user interfaces, and one or more machine interfaces.

One of skill in the art will recognize that features of logic described with respect to a rodent abatement system 100b, 100c, 100d, 100n may also be implemented in the other logic 142 of a remote computing device 140, and vice versa.

In some cases, one or both of the rodent abatement system 100b, 100c, 100d, 100n and the other logic 142 of a remote computing device 140 may perform geostatistical calculations to predict a population of targeted rodents, feeding patterns, bait exhaustion, or any other predictive information.

Optionally, the rodent abatement system 100b may include a carcass collection module 136 to receive a targeted rodent after it is released from the electrode subsystem. As described herein, the chamber 102 of the rodent abatement system 100b is self-clearing. That is, after the electrodes 112 are energized and eradicate a target rodent, the eradicated rodent will release its grip on the electrodes 112, and the rodent will drop into the carcass collection module 136. In some cases, such as when an eradicated rodent is stunned but not killed, the living rodent will be captured and contained in the carcass collection module 136. The captured rodent may be relocated, used as a food source, used for testing purposes, or used in some other way.

In at least some cases, for example where a carcass collection module 136 is not included, scavenger animals will dispose of a target rodent's body after it has fallen from the chamber 102.

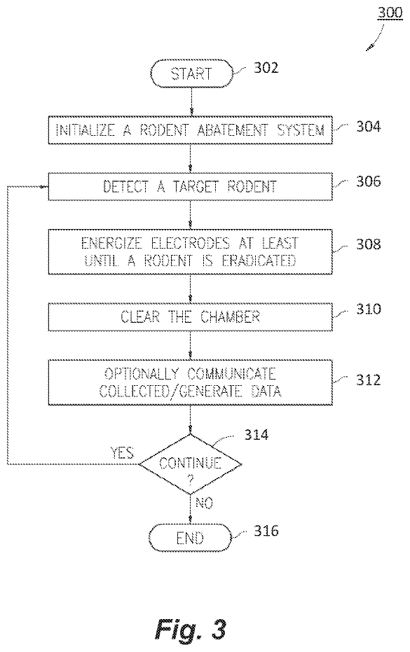

FIG. 3 is a data flow diagram representing a rodent abatement process 300. Embodiments in accordance with claimed subject matter may include all of, less than, or more than modules 302 through 316. Also, the order of modules 302 through 316 are shown in merely an exemplary order. Modules and data flow in other orders are also contemplated. Operations of the rodent abatement process 300 may be enabled via a processor 118, 118b executing processor circuit-executable instructions stored in a memory 120, 120b. The operations may be directed in whole or in part via data provided by sensors of a sensor subsystem 122.

The rodent abatement process begins at 302.

At 304, the rodent abatement system is initialized. Processing falls to 306.

At 306, a target rodent is detected. Upon detection, which may occur by input from a sensor, predication by a complex computing algorithm (e.g., artificial intelligence), or some other means, an energizing of one or more graspable electrodes 112 is triggered. Processing falls to 308.

At 308, based on the trigger, graspable electrodes 112 are energized, and the rodent is eradicated. Processing falls to 310.

At 310, the rodent is cleared from chamber 102. Processing falls to 312.

At 312, certain data is communicated. In some cases, data collected or otherwise generated in the rodent abatement system 100 such as alerts and system status is communicated from the rodent abatement system 100. Additionally, or alternatively, certain data such as one or more control parameters is communicated to a rodent abatement system 100. Processing falls to 314.

At 314, a decision is determined whether or not to continue operations of the rodent abatement system. If operations are to continue, processing advances back to 306. If operations are to end, processing falls to 316.

At 316, processing ends.

FIGS. 4A-4B are first and second embodiments of a rodent abatement system 100c prototype. FIG. 4C is an embodiment of another rodent abatement system 100d prototype. FIGS. 4D-4F are first, second, and third embodiments of portions of yet one more rodent abatement system 100e prototype. In the present disclosure, FIGS. 4A-4F may be collectively referred to as FIG. 4. Structures earlier identified are not repeated for brevity. Each of the rodent abatement system 100c, 100d, 100e prototypes are along the lines of the rodent abatement systems 100, 100b of FIGS. 1 and 2.

The rodent abatement system 100c prototype of FIGS. 4A-4B includes a first contact platform (e.g., graspable electrode 112h of a hardware cloth, metal mesh, or the like) that is electrically coupled to a high energy power supply 110 (not shown in FIG. 4) of a control system 108. The high energy power supply 110 is also coupled to one or more additional electrodes 112i, 112j. In at least some cases, a first paw electrode 112i and a foot electrode 112h are electrically coupled to a negative or ground potential and a second paw electrode 112j is coupled to at positive or supply potential. When a target rodent contacts at least two of the electrodes 112h, 112i, 112j that have a different potential, the high energy power supply 110 is activated to pass energy through the paws, chest, legs, feet, or other anatomical structures of the target rodent, and the target rodent is eradicated. In other cases, the first foot electrode 112h is coupled to a negative or ground potential, and first and second paw electrodes 112i, 112j are coupled to at positive or supply potential. In still other cases, the first foot electrode 112h is coupled to a first potential, and a first paw electrodes 112i, is coupled to a second potential, and a second paw electrodes 112j is coupled to a third potential. Each of the contemplated embodiments is arranged to create a power differential that exceeds a let-go threshold when a target rodent grasps at least one first electrode 112 and is in contact with at least one second electrode 112.

The prototype of FIGS. 4A-4B is arranged to encourage a target rodent to stand on its hind legs and reach into the chamber 102 towards a bait in the attractant platform 114. In this circumstance, because the inside of chamber 102 is sized for the target rodent (e.g., discouraging other rodents from entering the chamber) and generally smooth, the target rodent will attempt to climb or otherwise pull itself toward the attractant (i.e., bait) by grasping one or both of the first and second paw electrodes 112i, 112j. In the prototype of FIGS. 4A-4B, energy (e.g., current) is intended to flow from left to right paws and through the chest of the target rodent, and some energy (e.g., current) also flows through the body, rear legs, and feet of the target rodent. In at least some cases, a metallic (e.g., copper, aluminum, galvanized steel, or the like) foil contact electrode 112 (not shown) inside the chamber may also be arranged to pass energy (e.g., current) through the neck and head of the target rodent if the nose or ears touch the foil. It is known by those of skill in the art that passing sufficient energy (e.g., current) through the brain causes almost instant unconsciousness of the rodent, which can completely reduce or remove any pain from the target rodent.

In at least some cases of the prototype of FIGS. 4A-4B, a steel junction box measuring about four inches (4 in.) by four inches (4 in.) by one and one-half inches (1.5 in.) contains the control system 108 and includes a light-sensitive array arranged to convert light to electrical energy for use by the control system 108. The control system 108 is arranged to deliver about 6000 volts in a pulsed 240 Hz electrical signal via the electrodes 112h, 112i, 112j, but many other electrical parameters are also contemplated.

In the rodent abatement system 100c prototype, the chamber 102 includes a base station 134 arranged as a wooden frame with an electrode platform 146, a chamber 102 arranged as a tunnel, and an attractant access portal 116 arranged as a chamber cap. The tunnel and chamber cap are formed of four inch (4 in.) square, white, PVC fencing post material. The chamber 102 is suitable for outdoor use. The white PVC is translucent so that the interior volume of the chamber's tunnel is not dark during daylight hours, electrically non-conductive, and slippery to the targeted rodent's paws. In this configuration, the electrodes 112h, 112i, 112j offer the only easily graspable surfaces in the interior volume of the chamber 102.

In the prototype of FIGS. 4A-4B, the chamber size and electrode location are appropriate for a targeted gray squirrel's size. The attractant access portal 116 also functions to prevent rain and animals entering the chamber 102 from above. A length of elasticized (e.g., bungie) cord secures the attractant access portal 116 (e.g., chamber cap) of the chamber 102 to the interior volume of the chamber 102, but other arrangements are of course contemplated.

In the prototype of FIGS. 4A-4B, an attractant platform 114 is formed from a transparent plastic vessel (e.g., a “TIC-TAC” box). In this case, the attractant platform 114 is suspended from a removable attractant access portal 116 (e.g., chamber cap) at an appropriate distance above the electrodes 112i, 112j to encourage the target rodent to place its front paws on upper graspable electrodes 112i 112j while the rodent is standing on lower electrodes 112h. The removable attractant access portal 116 facilitates attractant loading on or in the attractant platform 114. The attractant platform 114 in the rodent abatement system 100c prototype is clear plastic with vent holes being located near the top and bottom. This construction allows the target rodent to see and smell the attractant. A target rodent is therefore attracted by an attractant in the attractant platform 114, but the rodent is unable to access and deplete the attractant. It has been learned in testing by the inventor that nuts (e.g., peanuts, walnuts, or others) are an appropriate attractant for squirrels. Other attractants, attractant platform 114 configurations, and attractant access portals 116 are contemplated.

When deployed, the chamber 102 of the rodent abatement system 100c prototype is attached to a base station 134 via mounting structures 144 of any suitable type. The chamber 102 in FIGS. 4A-4B is mounted with an open, proximal end of the chamber 102 facing down. In some cases, the inventor has discovered that the prototype operates effectively if the chamber 102 is placed in an elevated position on a tree trunk. The height at which the chamber 102 is mounted may vary, but the inventor has discovered that mounting at a height greater than 8 feet places the rodent abatement system 100c prototype out of reach of humans and many other non-target animals. A periodic inspection based on the expected effective life of the attractant or lure and to assess the battery is condition is all that is needed for the trap to operate for an indefinite period.

Turning to FIG. 4C, the rodent abatement system 100d prototype is further along the lines of the rodent abatement system 100c of FIGS. 4A-4B, albeit with a differently shaped (e.g., a triangular cross section) chamber 102. In FIG. 4C, the control system 108 may stand alone in some cases, and the compartment containing control system 108 may also contain a power source such as a battery, a photovoltaic device, or some other power storage means or power generating means in other cases. In at least some embodiments, the chamber 102 of FIG. 4C (and other embodiments) may contain only two electrodes 112 across which a power signal that exceeds a let-go threshold may be delivered.

It has been learned by the inventor that the prototype of FIG. 4C is a minimalist embodiment effective to eradicate gray squirrels, Sciurus carolinensis, native to eastern North America. Gray squirrels have been ranked as one of the top one hundred invasive species worldwide. Gray squirrels are believed to be the cause of significant harm in the United Kingdom.

In the embodiment 100d of FIG. 4C, an attractant platform 114 is arranged alongside the chamber 102 rather than above the chamber 102 as in the embodiment 100c of FIGS. 4A-4B. The attractant platform 114 is a clear vessel, and in this way, the replenishment of bait may be made easier. In some cases, the embodiment 100d of FIG. 4C may contain electronics, telecommunications, or other structures as described herein.

Turning next to the rodent abatement system 100e prototype of FIGS. 4D-4F, this prototype is intended to eradicate mice and rats. As evident in FIG. 4E, lower graspable electrodes 112k are electrically insulated from upper graspable electrodes 112l via one or more insulators 170. The insulator 170 may be a physical separation (e.g., ambient air) in some cases, and the insulator 170 may be or otherwise include a structure of any suitable material (e.g., plastic, rubber, ceramic, or some other material).

In the embodiment 1004, the lower graspable electrodes 112k are electrically coupled to a negative (−) or ground potential of the power supply 110 (not shown in FIGS. 4D-4F), and the upper graspable electrodes 112l are electrically coupled to a positive (+) or supply potential of the power supply 110. The upper graspable electrodes 112l are arranged as a contact point for the target rodent's front paws. The lower graspable electrode 112k is arranged as a contact point for the target rodent's rear paws.

In the rodent abatement system 100e prototype of FIGS. 4D-4F, the chamber is formed from a clear, eight inch (8 in.) long, two inch (2 in.) diameter PVC pipe. Embodiments having other dimensions are also contemplated. The embodiments may be transparent or translucent of any suitable color, thickness, and material. The chamber 102 is intended to be substantially vertical (e.g., vertical or steeply inclined) on a portable base station 134 or existing base station structure. The attractant platform 114 is arranged in the distal (e.g., top) portion of the chamber 102 (FIG. 4F). The attractant platform may be wire mesh, as described herein. In some cases, the attractant platform 114 may also be arranged as an electrode 112.

The rodent abatement system 100e prototype may include a screw-on form of the attractant access portal 116 (e.g., cap, cover, lid, or the like) which would be coupled to the chamber 102 via the threads shown in FIG. 4E or via some other means. When a target rodent is a mouse or rat, the inventor has discovered that mounting the chamber 102 so that the proximal (e.g., bottom) entrance is about four inches to eight inches (4 in. to 8 in.), and preferably five inches (5 in.), above a substantially horizontal surface accessible to a rat or mouse permits the target rodent to access the interior volume of the chamber 102 and still allows the carcass to fall clear of the chamber when the target rodent is eradicated.

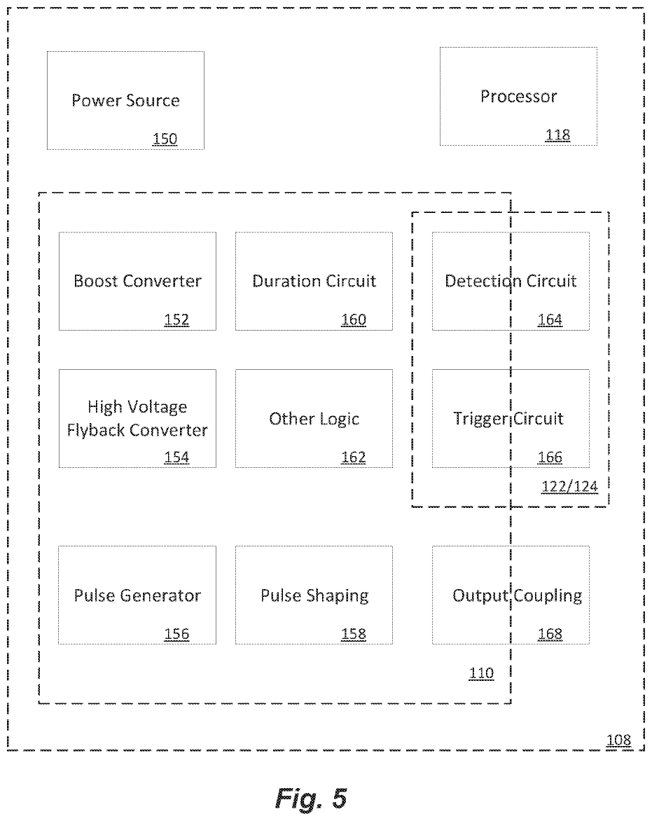

FIG. 5 is a partial view of a control system 108 of any rodent abatement system 100 of the present disclosure. FIG. 5 includes a power supply 110 circuitry arranged to generate, from a 6-volt battery, a 6000 volt pulsed electrical output signal that operates for 20 seconds. The circuitry of FIG. 5, or another power supply circuit, may provide a suitable energy signal to electrodes 112 of any rodent abatement system 100 of the present disclosure. In FIG. 5, the power supply circuit 110 includes an optional boost converter 152, an optional high voltage flyback converter 154, an optional pulse generator 156, an optional pulse shaping circuit 158, a duration circuit 160, and optional other logic 162. In some cases, detection circuitry 164 may be part of a power supply 110, and in these or other cases, the detection circuitry 164 may be provided by sensor subsystem 122 (FIG. 1B). In some cases, a trigger circuit 166 may be part of a power supply 110, and in these or other cases, the trigger circuitry 166 may provided by trigger 124 (FIG. 1B).

In some cases, as described herein, operations of the power supply 110 are partially or completely controlled by processor 118. Such operations may include interrogating sensors, controlling energy signals provided to electrodes 112, controlling energy parameters of the power supply 110, controlling the duration of an energy signal provided to electrodes 112, communicating with remote computing servers 140, communicating with other rodent abatement systems 100, and performing other such functions.

Power source 150 in FIG. 5 is a battery or set of batteries arranged to provide six volts (6 v) to the power supply 110. The power source 150 may be a disposable battery source or a rechargeable battery source. Other power sources 150 such as mains power or line (alternating current (AC)) power. In these cases, additional circuitry may be arranged to rectify, smooth, or otherwise condition the initial power for power supply 110. In still other cases, power source 150 may include solar power, batteries of different characteristics, or some other power source.

Energy from the power source 150 is received at a boost converter circuit 152. The boost converter circuit 152 of FIG. 5 is arranged to increase voltage from six volts (6 v) to about 50 volts to 150 volts via a transformer in some cases, a semiconductor-controlled capacitive and/or inductive circuit in some cases, or another power boost or power regulator circuit in still other cases. In some embodiments, the boost converter 152 is a known switched-mode power supply (SMPS) arranged to increase voltage at an output via decreasing current sourced at an input. The output of the boost converter circuit 152 in FIG. 5 is provided to an optional high voltage flyback converter 154 circuit.

The optional high voltage flyback converter 154 circuit of FIG. 5 is an inductor-based, semiconductor controlled circuit arranged to produce the underlying high voltage signal that will conditioned and applied to electrodes 112. In FIG. 5, the high voltage flyback converter 154 produces a 6000 volt signal.

The pulse generator circuit 156 and pulse shaping circuit 158 cooperate to produce the electrical signal that is delivered to electrodes 112 of any rodent abatement system 100 of the present disclosure. The electrical signal produced by the pulse generator circuit 156 and pulse shaping circuit 158 exceeds the let-go threshold of a targeted rodent. Such electrical signal may be arranged as a square wave, sawtooth wave, pulse-width modulated wave, or a signal having some other such characteristics.

The duration circuit 160 will control the duration of time that the electrical signal produced by the pulse generator circuit 156 and pulse shaping circuit 158 will be applied to electrodes 112. The duration circuit may include a timer of any known configuration (e.g., resistive-capacitive timer, 555 integrated circuit timer, a processor-based counter). In at least some cases, the parameters of the duration circuitry 160, the function of the duration circuitry 160, or other aspects of the duration circuitry may be provided by processor 118. In the power supply 110 of FIG. 5, the duration circuitry provides a 20 second timing cycle for the provision of electrical energy to electrodes 112.

Power supply 110 optionally includes other logic 162. The other logic 162 may be arranged for any suitable functionality. The other logic 162 may include safety circuitry such as ground-fault circuit interruption (GFCI) during servicing of the rodent abatement system 100. The other logic 162 may include circuitry to count cycles of operation of the power supply 110, days in service, hours in service, time between baiting or re-baiting the rodent abatement system 100 or other timing-related functions. In still other cases, the other logic 162 is arranged to provide service functions, operational functions, reporting functions, interface functions, or still other functions.

The output coupling circuit 168 is arranged to communicate the electrical signal that exceeds the let-go threshold of a targeted rodent from the power supply to electrodes 112 of any rodent abatement system 100 of the present disclosure. The communication may be via wires or other electrical conduits. The output coupling circuit 168 may include pads, lugs, connectors, insulators, a terminal block, or any other suitable coupling circuitry.

Having now set forth certain embodiments, further clarification of certain terms used herein may be helpful to providing a more complete understanding of that which is considered inventive in the present disclosure.

Within the present disclosure, the word “proximate” is used to mean a suitable location near a particular point of interest. The suitable location may be within inches, within feet, or within some other suitable distance as the context requires. For example, an attractant platform 114 placed proximate an electrode may be close enough that a target rodent can see, smell, or otherwise perceive a path to the attractant by using its paws to climb two or more suitably sized and shaped graspable electrodes 112. In such cases, the attractant platform may be one inch from an electrode 112, two inches from an electrode 112, six inches from an electrode 112, or some other distance. An attractant platform 114 placed many feet from an electrode 112 would generally not be considered “proximate” the electrode 112. In some of these cases, whether or not an attractant platform 114 is proximate an electrode 112 may be related to the type and constitution of a particular attractant (e.g., raw fish versus kibble). As another guide, a chamber 102 proximately placed near the ground may be eight to twelve feet off of the ground. This proximate distance is desirably low enough that a target rodent can access the chamber 102 from an area where the rodent might normally traverse yet desirably high enough that a human or non-target rodent can't easily access the chamber 102.

FIG. 3 includes a data flow diagram illustrating a non-limiting process that may be used by embodiments of a rodent abatement system 100. In this regard, each described process may represent a module, segment, or portion of software code, which comprises one or more executable instructions for implementing the specified logical function(s). It should also be noted that in some implementations, the functions noted in the process may occur in a different order, may include additional functions, may occur concurrently, and/or may be omitted.

The figures in the present disclosure illustrate portions of one or more non-limiting computing device embodiments such as one or more components of control system 108 and remote computing device 140. The computing devices may include operative hardware found in conventional computing device apparatuses such as one or more processors, volatile and non-volatile memory, serial and parallel input/output (I/O) circuitry compliant with various standards and protocols, wired and/or wireless networking circuitry (e.g., a communications transceiver), one or more user interface (UI) modules, logic, and other electronic circuitry.

The present application discusses several embodiments that include or otherwise cooperate with one or more computing devices. It is recognized that these computing devices are arranged to perform one or more algorithms to implement various concepts taught herein. Each of said algorithms is understood to be a finite sequence of steps for solving a logical or mathematical problem or performing a task. Any or all of the algorithms taught in the present disclosure may be demonstrated by formulas, flow charts, data flow diagrams, narratives in the specification, and other such means as evident in the present disclosure. Along these lines, the structures to carry out the algorithms disclosed herein include at least one processing device executing at least one software instruction retrieved from at least one memory device. The structures may, as the case may be, further include suitable input circuits known to one of skill in the art (e.g., keyboards, buttons, memory devices, communication circuits, touch screen inputs, and any other integrated and peripheral circuit inputs (e.g., accelerometers, thermometers, light detection circuits and other such sensors)), suitable output circuits known to one of skill in the art (e.g., displays, light sources, audio devices, tactile devices, control signals, switches, relays, and the like), and any additional circuits or other structures taught in the present disclosure. What's more, the computing devices, electronics, state machines, and the like may be coupled to any number of mechanical structures. To this end, every invocation of means or step plus function elements in any of the claims, if so desired, will be expressly recited.

The computing devices illustrated herein may further include operative software found in a conventional computing device such as an operating system or task loop, software drivers to direct operations through I/O circuitry, networking circuitry, and other peripheral component circuitry. In addition, the computing devices may include operative application software such as network software for communicating with other computing devices, database software for building and maintaining databases, and task management software where appropriate for distributing the communication and/or operational workload amongst various processors. In some cases, the computing device is a single hardware machine having at least some of the hardware and software listed herein, and in other cases, the computing device is a networked collection of hardware and software machines working together in a server farm to execute the functions of one or more embodiments described herein. Some aspects of the conventional hardware and software of the computing device are not shown in the figures for simplicity.

Some computing devices in the present disclosure generate data, and these and other computing devices consume data (e.g., a device that receives alerts, system status, and the like). Amongst other things, the exemplary computing devices of the present disclosure (e.g., control system 108 and remote computing device 140) may be configured in any type of mobile or stationary computing device such as a remote cloud computer, a computing server, a smartphone, a tablet, a laptop computer, a wearable device (e.g., eyeglasses, jacket, shirt, pants, socks, shoes, other clothing, hat, helmet, other headwear, wristwatch, bracelet, pendant, other jewelry), vehicle-mounted device (e.g., train, plane, helicopter, unmanned aerial vehicle, unmanned underwater vehicle, unmanned land-based vehicle, automobile, motorcycle, bicycle, scooter, hover-board, other personal or commercial transportation device), industrial device (e.g., factory robotic device, home-use robotic device, retail robotic device, office-environment robotic device), or the like. Accordingly, the computing devices include other components and circuitry that is not illustrated, such as, for example, a display, a network interface, memory, one or more central processors, camera interfaces, audio interfaces, and other input/output interfaces. In some cases, the exemplary computing devices may also be configured in a different type of low-power device such as a mounted video camera, an Internet-of-Things (IoT) device, a multimedia device, a motion detection device, an animal detection device, a security device, a wildlife monitoring device, or some other device.

When so arranged as described herein, each computing device may be transformed from a generic and unspecific computing device to a combination device arranged comprising hardware and software configured for a specific and particular purpose such as to provide a determined technical solution. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The embodiments described herein use computerized technology to improve the technology of rodent abatement, but there are other techniques and tools that remain available to eradicate targeted rodents. Therefore, the claimed subject matter does not foreclose the whole or even substantial rodent abatement technological area. The innovation described herein uses both new and known building blocks combined in new and useful ways along with other structures and limitations to create something more than has heretofore been conventionally known. The embodiments improve on computing systems which, when un-programmed or differently programmed, cannot perform or provide the specific rodent abatement operations and system features claimed herein. The embodiments described in the present disclosure improve upon known rodent abatement processes and techniques. The computerized acts described in the embodiments herein are not purely conventional and are not well understood. Instead, the acts are new to the industry. Furthermore, the combination of acts as described in conjunction with the present embodiments provides new information, motivation, and business results that are not already present when the acts are considered separately. There is no prevailing, accepted definition for what constitutes an abstract idea. To the extent the concepts discussed in the present disclosure may be considered abstract, the claims present significantly more tangible, practical, and concrete applications of said allegedly abstract concepts. And said claims also improve previously known computer-based systems that perform rodent abatement operations.

Software may include a fully executable software program, a simple configuration data file, a link to additional directions, or any combination of known software types. When a computing device updates software, the update may be small or large. For example, in some cases, a computing device downloads a small configuration data file to as part of a software update, and in other cases, a computing device completely replaces most or all of the present software on itself or another computing device with a fresh version. In some cases, software, data, or software and data is encrypted, encoded, and/or otherwise compressed for reasons that include security, privacy, data transfer speed, data cost, or the like.

Database structures, if any are present in the rodent abatement systems described herein, may be formed in a single database or multiple databases. In some cases, hardware or software storage repositories are shared amongst various functions of the particular system or systems to which they are associated. A database may be formed as part of a local system or local area network. Alternatively, or in addition, a database may be formed remotely, such as within a distributed “cloud” computing system, which would be accessible via a wide area network or some other network.

Input/output (I/O) circuitry and user interface (UI) modules include serial ports, parallel ports, universal serial bus (USB) ports, IEEE 802.11 transceivers and other transceivers compliant with protocols administered by one or more standard-setting bodies, displays, projectors, printers, keyboards, computer mice, microphones, micro-electro-mechanical (MEMS) devices such as accelerometers, and the like.

In at least one embodiment, devices such as the control system 108 may communicate with other devices via communication over a network. The network may involve an Internet connection or some other type of local area network (LAN) or wide area network (WAN). Non-limiting examples of structures that enable or form parts of a network include, but are not limited to, an Ethernet, twisted pair Ethernet, digital subscriber loop (DSL) devices, wireless LAN, Wi-Fi, Worldwide Interoperability for Microwave Access (WiMax), or the like. In the present disclosure, memory may be used in one configuration or another.

The memory may be configured to store data. In the alternative or in addition, the memory may be a non-transitory computer readable medium (CRM). The CRM is configured to store computing instructions executable by a processor of the control system 108 or remote computing device 140. The computing instructions may be stored individually or as groups of instructions in files. The files may include functions, services, libraries, and the like. The files may include one or more computer programs or may be part of a larger computer program. Alternatively, or in addition, each file may include data or other computational support material useful to carry out the computing functions of a rodent abatement system 100.

Buttons, keypads, computer mice, memory cards, serial ports, bio-sensor readers, touch screens, and the like may individually or in cooperation be useful to a service person operating the rodent abatement system 100. The devices may, for example, input control information into the system. Displays, printers, memory cards, LED indicators, temperature sensors, audio devices (e.g., speakers, piezo device, etc.), vibrators, and the like are all useful to present output information to the service person operating the rodent abatement system. In some cases, the input and output devices are directly coupled to the control system 108 and remote computing device 140 and electronically coupled to a processor or other operative circuitry. In other cases, the input and output devices pass information via one or more communication ports (e.g., RS-232, RS-485, infrared, USB, etc.).

As described herein, for simplicity, a service person may in some cases be described in the context of the male gender. It is understood that a service person can be of any gender, and the terms “he,” “his,” and the like as used herein are to be interpreted broadly inclusive of all known gender definitions. As the context may require in this disclosure, except as the context may dictate otherwise, the singular shall mean the plural and vice versa; all pronouns shall mean and include the person, entity, firm or corporation to which they relate; and the masculine shall mean the feminine and vice versa.

The terms, “real-time” or “real time,” as used herein and in the claims that follow, are not intended to imply instantaneous processing, transmission, reception, or otherwise as the case may be. Instead, in the context of computing systems, the terms, “real-time” and “real time” imply that the activity occurs in a digital fashion over an acceptably short period of time (e.g., over a period of microseconds or milliseconds), and that the activity may be performed on a constant or otherwise digitally ongoing basis (e.g., measuring resistance or impedance amongst electrodes 112, detecting motion or sound in the interior volume of a chamber 102, and the like). Additionally, or alternatively, monitoring a power supply 110 or attractant source in an attractant platform 114 in a rodent abatement system 100 via alerts to a remote computing device may occur in real time when the alert is received in seconds or even minutes. An example of a digital activity that is not real-time is one that occurs over an extended period of time (e.g., hours or days). An example of a rodent abatement monitoring activity that is not real-time is one that occurs over an extended period of time (e.g., days, weeks, or months) or that occurs only based on intervention or direction by a service person or other activity.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a chamber 102 may be described as being mounted or otherwise oriented “substantially vertical.” In these cases, a chamber 102 that is oriented exactly vertical is oriented along a “Z” axis that is normal (i.e., 90 degrees or at right angle) to a plane formed by an “X” axis and a “Y” axis such as the ground. Different from the exact precision of the term, “vertical,” the use of “substantially” to modify the characteristic permits a variance of the “vertical” characteristic by up to 30 percent. Accordingly, a chamber 102 that is oriented “substantially vertical” includes chambers 102 oriented between 63 degrees and 117 degrees. A chamber 102 that is oriented at 45 degrees of an X-Y plane, however, is not mounted “substantially vertical.” As another example, a chamber 102 having a particular linear dimension of “between about four inches (4 in.) and ten inches (10 in.)” includes such devices in which the linear dimension varies by up to 30 percent, Accordingly, the particular linear dimension of the chamber 102 may be between one inch (1 in.) and thirteen inches (13 in.).

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, the technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

In the present disclosure, when an element (e.g., component, circuit, device, apparatus, structure, layer, material, or the like) is referred to as being “on,” “coupled to,” or “connected to” another element, the elements can be directly on, directly coupled to, or directly connected to each other, or intervening elements may be present. In contrast, when an element is referred to as being “directly on,” “directly coupled to,” or “directly connected to” another element, there are no intervening elements present.

The terms “include” and “comprise,” as well as derivatives and variations thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the present disclosure, the terms first, second, etc., may be used to describe various elements, however, these elements are not to be limited by these terms unless the context clearly requires such limitation. These terms are only used to distinguish one element from another. For example, a first machine could be termed a second machine, and, similarly, a second machine could be termed a first machine, without departing from the scope of the inventive concept.

The singular forms of “a,” “an,” and “the” in the present disclosure include plural referents unless the content and context clearly dictates otherwise. The conjunctive terms, “and” and “or,” are generally employed in the broadest sense to include “and/or” unless the content and context clearly dictates inclusivity or exclusivity as the case may be. The composition of “and” and “or” when recited herein as “and/or” encompasses an embodiment that includes all of the elements associated thereto and at least one more alternative embodiment that includes fewer than all of the elements associated thereto.

In the present disclosure, conjunctive lists make use of a comma, which may be known as an Oxford comma, a Harvard comma, a serial comma, or another like term. Such lists are intended to connect words, clauses, or sentences such that the thing following the comma is also included in the list.

The headings and Abstract of the Disclosure provided herein are for convenience only and do not interpret the scope or meaning of the embodiments.

The electrical energy-based systems, devices, and methods described in the present disclosure provide several technical effects and advances to the field of rodent abatement. Technical effects and benefits include the ability to safely and humanely eradicate targeted animals, capture certain animals, control the population of certain animals, or perform other acts related to certain animals. Such acts may include research studying the effects on animals of various sizes to determine that the amount of electrical energy (e.g., voltage, current, power, frequency, and other such electrical energy characteristics) required for a given effect is approximately proportionate to body weight.

Electrical energy that exceeds the let-go threshold of at least one prehensile body part of an animal causes an involuntary contraction of the affected muscles, thereby overriding the animal's ability to release from a climbing or otherwise graspable surface until the energy is removed or the animal's muscles fatigue, become unresponsive, and relax. In prehensile paws, for example, the flexor muscles overpower the opposing extensor muscles thereby tightening the grasp of the paw. When the electrical energy exceeds the let-go threshold and causes an involuntary contraction of the affected muscles of the animal, the resulting effect is tetanic reaction (e.g., a body rigidity) in at least some cases until the targeted rodent is eradicated.

Some embodiments taught in the present disclosure have two or more electrically conductive surfaces, vertically oriented and insulated from each other, with one or more of the electrically conductive surfaces having a texture arranged to be grasped by the target animal's prehensile paws. At least some of these and other embodiments are traps arranged such that the animal is in a standing or substantially vertical climbing attitude that permits the animal, when it becomes unconscious and its grasp relaxes, to fall clear of the trap. The trap can then automatically or by some trigger reset itself for the next animal. To help visualize but not limit embodiments of the invention, the animal's paws can be seen as replacing the function of mechanical jaws and trap doors in conventional rodent abatement traps.

Embodiments of the electrical energy signals (e.g., voltage, current, power, waveform, frequency, duration, and other electrical energy characteristics) can be tailored for any desired effect or effects in the target animal while reducing harm to non-target species. In some embodiments, electrical energy in excess of the let-go threshold of a target animals prehensile body part overrides the animal's ability to release from the climbing (i.e., grasped) surface until the current is removed or the muscles fatigue, become unresponsive, and relax.

The present disclosure sets forth details of various structural embodiments that may be arranged to carry the teaching of the present disclosure. By taking advantage of the flexible circuitry, mechanical structures, processor architecture, and other means described herein, a number of exemplary devices and systems are now disclosed.

Example A-1 is an apparatus, comprising: a containment chamber; an electrically conductive member; and a power supply, the power supply coupled to the electrically conductive member and arranged to deliver an electric signal to the electrically conductive member, the electric signal having sufficient energy to exceed a let-go threshold of a rodent's prehensile body part.

Example B-1 is a method to eradicate targeted rodents, comprising: a containment chamber; positioning a containment chamber at a location accessible to a rodent, the containment chamber having an electrically conductive member; and providing an electric signal to the electrically conductive member for a selected duration, the electric signal having sufficient energy to exceed the let-go threshold of the rodent's prehensile body part, the selected duration being at least five-hundred milliseconds (500 msec).

Example B-2 may include the subject matter of Example B-1, and alternatively or additionally any other example herein, wherein the selected duration is at least one second (1 sec).

Example B-3 may include the subject matter of any of Examples B-1 to B-2, and alternatively or additionally any other example herein, wherein the selected duration is at least two seconds (2 secs).

Example B-4 may include the subject matter of any of Examples B-1 to B-3, and alternatively or additionally any other example herein, wherein the selected duration is at least three seconds (3 secs).

Example B-5 may include the subject matter of any of Examples B-1 to B-4, and alternatively or additionally any other example herein, wherein the selected duration is at less than three hundred seconds (300 secs).

Example C-1. Is a system, comprising: a chamber having any extent of containment, for example a substantially cylindrical form factor, the chamber made at least in part from a non-conductive material, the chamber having a proximal end, a distal end, and an interior volume that has a substantially smooth surface, the chamber sized to accept entry of a targeted rodent at its proximal end; a power supply; and an electrode subsystem electrically coupled to the power supply.

Example C-2 may include the subject matter of any of Example C-1, and alternatively or additionally any other example herein, wherein the electrode subsystem is positioned at the proximal end of the chamber; and an accessible attractant platform is positioned at the distal end of the chamber when the system is deployed.

Example D-1 is a method, comprising: providing an electrical current in excess of the let-go threshold of a prehensile body part of an animal; applying the electrical current to an object; and restraining the animal when involuntary muscle contractions of the prehensile body part of the animal cause the animal's prehensile body part to maintain a grasp of the object.

Example F-1 is a method, comprising: detecting a change in ambient conditions proximate an animal detection structure; generating an electric signal with a high-energy circuit; providing the electric signal between a plurality of electrodes that are electrically coupled to the high-energy circuit; automatically activating at least a portion of said high-energy circuit based on the change in ambient conditions; and delivering, by said high-energy circuit upon said automatic activation, a series of pulses of energy in excess of the let-go threshold of a prehensile body part of an animal at a certain frequency when the animal is concurrently contacting at least two of said plurality of electrodes for a determined time period.

Example F-2 may include the subject matter of Example F-1, and alternatively or additionally any other example herein, wherein detecting the change in ambient conditions includes at least one of detecting a change in motion, detecting a change in temperature, detecting a change in weight, detecting a change in light, detecting a change in humidity, detecting a change in air flow, detecting a change in sound, and detecting a change in electrical conditions.

Example F-3 may include the subject matter of any of Examples F-1 to F-2, and alternatively or additionally any other example herein, wherein detecting the change in ambient conditions includes detecting the animal.

Example F-4 may include the subject matter of Examples F-1 to F-3, and alternatively or additionally any other example herein, wherein the detection structure includes at least one of a motion detector, a thermometer, a load sensor, a light sensor, a humidity sensor, a gas flow sensor, and a microphone.

Example F-5 may include the subject matter of any of Examples F-1 to F-4, and alternatively or additionally any other example herein, wherein the detection structure includes at least one micro-electro-mechanical (MEMS) device.

Example F-6 may include the subject matter of any of Examples F-1 to F-5, and alternatively or additionally any other example herein, wherein the detection structure includes at least one circuit arranged to detect a change in capacitance, resistance, or impedance.

Example F-7 may include the subject matter of any of Examples F-1 to F-6, and alternatively or additionally any other example herein, wherein at least one of the plurality of electrodes is being grasped by the animal's prehensile body part.

Example F-8 may include the subject matter of any of Examples F-1 to F-7, and alternatively or additionally any other example herein, wherein the frequency, determined time period, amount of energy, and series of pulses of energy passing through the animal's body are appropriate to restrain, stun, or kill the animal.

Example G-1 is an electronic animal trap comprising: a power source; a plurality of electrodes, at least one of the electrodes being suitable for grasping by a target animal's prehensile body part; a high energy circuit capable of supplying energy in excess of the let-go threshold of the target animal's prehensile body part when said target animal is coupled to said at least one of the electrodes, said high energy circuit automatically activating in response to detection of the target animal contacting at least two of the plurality of electrodes such that said high energy circuit delivers said energy between said at least two of the plurality of electrodes for a time period; and a processing unit configured to: direct a termination of the delivery of energy between said at least two of the plurality of electrodes upon completion of said time period; and automatically re-arm said electronic animal trap based on a detection that said target animal has cleared said electronic animal trap.

Example G-2 may include the subject matter of Example G-1, and alternatively or additionally any other example herein, wherein the energy is a direct current energy.

Example G-3 may include the subject matter of any of Examples G-1 to G-2, and alternatively or additionally any other example herein, wherein the energy is a pulsed energy.

Example G-4 may include the subject matter of any of Examples G-1 to G-3, and alternatively or additionally any other example herein, wherein the energy is a pulse width modulated energy.

Example G-5 may include the subject matter of any of Examples G-1 to G-4, and alternatively or additionally any other example herein, wherein the energy is an alternating current or some other type of pulsed or reciprocating energy.

Example G-6 may include the subject matter of any of Examples G-1 to G-5, and alternatively or additionally any other example herein, wherein the animal is one of a rodent, a mustelid, a possum, a raccoon, a primate, and a reptile.

Example G-7 may include the subject matter of any of Examples G-1 to G-6, and alternatively or additionally any other example herein, wherein at least one of the plurality of electrodes has a shape that invites the animal to climb or otherwise grasp.

Example G-8 may include the subject matter of any of Examples G-1 to G-7, and alternatively or additionally any other example herein, wherein the electronic animal trap includes a chamber, the chamber having a generally cylindrical form factor.

Example G-9 may include the subject matter of any of Examples G-1 to G-8, and alternatively or additionally any other example herein, wherein the electronic animal trap includes a chamber, the chamber formed from a poly-chloride vinyl (PVC) pipe.

Example G-10 may include the subject matter of any of Examples G-1 to G-9, and alternatively or additionally any other example herein, wherein the electronic animal trap includes a chamber, the chamber having a circular, square, rectangular, pentagonal, hexagonal, or octagonal shaped cross section when the chamber is cut normal its longest length.

Example G-11 may include the subject matter of any of Examples G-1 to G-10, and alternatively or additionally any other example herein, wherein the electronic animal trap includes a chamber, the chamber having an irregular shaped cross section when the chamber is cut normal its longest length.

Example G-12 may include the subject matter of any of Examples G-1 to G-11, and alternatively or additionally any other example herein, wherein the electronic animal trap includes a chamber, the chamber having a length of between about three inches and fourteen inches (3 in. to 14 in.) and an inside diametrical dimension of between about one inch and eight inches (1 in. to 8 in.).

Example G-13 may include the subject matter of any of Examples G-1 to G-12, and alternatively or additionally any other example herein, wherein the electronic animal trap includes a chamber formed as an enclosure, a box, a tunnel, a screen, a shield, a cover, or some other extent of containment.

The various embodiments described above can be combined to provide further embodiments. Aspects of the embodiments can be modified, if necessary to employ concepts of the various patents, application and publications to provide yet further embodiments.

This application claims the benefit of priority to U.S. Provisional Application No. 63/384,599, filed Nov. 21, 2022, which application is hereby incorporated by reference in its entirety to the fullest extent permitted by the prevailing law.

In the description herein, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the preceding description, numerous details are set forth for the purpose of explanation. However, one of ordinary skill in the art should understand that embodiments may be practiced without the use of these specific details. In other instances, well-known structures and processes are not shown or described in order to avoid obscuring the description with unnecessary detail. Thus, the present disclosure is not intended to be limited to the embodiments shown but is instead to be accorded the widest scope consistent with the principles and features disclosed herein. Hence, these and other changes can be made to the embodiments in light of the above-detailed description. In general, in the following claims, the terms used should not be construed to limit the claims to the specific embodiments disclosed in the specification but should be construed to include all possible embodiments along with the full scope of equivalents to which such claims are entitled. Accordingly, the claims are not limited by the disclosure.

1. An apparatus, comprising:
a chamber;
an electrically conductive graspable member; and
a power supply, the power supply coupled to the electrically conductive graspable member and arranged to deliver an electric signal to the electrically conductive graspable member, the electric signal having sufficient energy to exceed a let-go threshold of a target rodent's prehensile body part.

2. The apparatus of claim 1 wherein the chamber has a length of at least three inches (3 in.) and a cross-sectional area of at least four square inches (4 sq. in.).

3. The apparatus of claim 1 wherein the chamber has an internal surface that is substantially smooth and generally slippery to a target rodent's paws.

4. The apparatus of claim 1 wherein the electrically conductive graspable member is arranged as a metal mesh structure.

5. The apparatus of claim 1, further comprising:
an electrode, the electrode coupled to the power supply and electrically isolated from the electrically conductive graspable member wherein the power supply is arranged to provide a first electrical potential to the electrically conductive graspable member and a second electrical potential, different from the first electrical potential, to the electrode.

6. The apparatus of claim 1 wherein the power supply includes at least one battery.

7. The apparatus of claim 1 wherein the power supply is arranged to deliver an electrical signal of between about 10 volts and about 50,000 volts.

8. The apparatus of claim 1 wherein the power supply is arranged to deliver an electrical signal as a pulsed direct current (DC) energy having a pulsing frequency of between about 10 Hz and about 1000 Hz.

9. The apparatus of claim 1, further comprising:
a trigger circuit arranged to detect the presence of the target rodent in the chamber.

10. The apparatus of claim 1, further comprising:
an attractant platform wherein the chamber has an open proximal end arranged to receive the target rodent into the chamber and a closed distal end, the attractant platform arranged proximate the closed distal end.

11. A method to eradicate targeted rodents, comprising:
positioning a chamber at a location accessible to a targeted rodent, the chamber having an electrically conductive graspable member; and
providing an electric signal to the electrically conductive graspable member for a selected duration, the electric signal having sufficient energy to exceed the let-go threshold of a target rodent's prehensile body part, the selected duration being at least five-hundred milliseconds (500 msec).

12. The method of claim 11, further comprising:
baiting an attractant platform, wherein the chamber has an open proximal end arranged to receive the target rodent into the chamber and a closed distal end, the attractant platform arranged proximate the distal end.

13. The method of claim 11 wherein providing the electric signal to the electrically conductive graspable member occurs after the target rodent is detected in the chamber and determined to be in contact with the electrically conductive graspable member.

14. The method of claim 11 wherein the electric signal has a voltage of between about 10 volts and about 50,000 volts and wherein the electric signal is a pulsed direct current (DC) energy having a pulsing frequency of between about 10 Hz and about 1000 Hz.

15. The method of claim 11 wherein the target rodent is a gray squirrel.

16. A system, comprising:
a chamber having a substantially cylindrical form factor, the chamber made at least in part from a non-conductive material, the chamber having a proximal end, a distal end, and an interior volume that has a substantially smooth surface that is generally slippery to a target rodent's paws, wherein the chamber sized to accept entry of the target rodent at its proximal end;
a power supply arranged to produce an electric signal having sufficient energy to exceed a let-go threshold of the target rodent's prehensile body part;
an electrode subsystem electrically coupled to the power supply and having at least one graspable electrode, the electrode subsystem positioned at the proximal end of the chamber; and
an accessible attractant platform positioned at the distal end of the chamber when the system is deployed.

17. The system of claim 16 wherein the chamber has a length of at least three inches (3 in.) and a cross-sectional area of at least four square inches (4 sq. in.), and wherein the chamber, when the system is deployed, is arranged in a substantially vertical alignment relative to the earth, the proximal end being closer to the earth than the distal end.

18. The system of claim 16 wherein the at least one graspable electrode is arranged as a metal mesh structure.

19. The system of claim 16 wherein the power supply is arranged to produce the electric signal having a voltage of between about 10 volts and about 50,000 volts as a pulsed direct current (DC) energy having a pulsing frequency of between about 10 Hz and about 1000 Hz.

20. The system of claim 16, further comprising:
a trigger circuit arranged to detect the presence of the target rodent in the chamber; and
a control circuit arranged to count at least one of a number of times the power supply produced the electric signal and the number of times the trigger circuit detected the presence of the target rodent.
